(19) United States
(12) Patent Application Publication
(10) Pub. No.: US 2022/0121952 A1
(43) Pub. Date: Apr. 21, 2022

(54) NON-HOMOGENEOUS MACHINE LEARNING ARCHITECTURE FOR APPROXIMATING AN OVERALL FUNCTION AND TRAINING METHOD THEREOF

(71) Applicant: Iruiz Contracting Limited, London (GB)

(72) Inventors: Ignacio Ruiz, London (GB); Mariano Zeron, London (GB)

(21) Appl. No.: 17/432,021

(22) PCT Filed: Feb. 18, 2020
(86) PCT No.: PCT/GB2020/050384

§ 371 Date: Aug. 18, 2021

(30) Foreign Application Priority Data
Feb. 18, 2019 (GB) 1902222.7

(51) Int. Cl. G06N 3/08; G06N 3/04; G06F 17/17

(52) U.S. Cl. CPC G06N 3/084; G06F 17/17; G06N 3/04

(57) ABSTRACT

The invention provides a non-homogeneous machine learning architecture for approximating an overall function as a composition of at least a first approximation function and a second approximation function. The non-homogeneous machine learning architecture comprises a neural network architecture for providing the first approximation function, the neural network architecture being configured to receive a plurality of input values for the overall function as an input to the first approximation function, and to apply the first approximation function to the received input values to generate a plurality of neural network output values. The non-homogeneous machine learning architecture comprises an interpolation architecture for providing the second approximation function, the interpolation architecture being configured to receive the plurality of neural network output values as an input to the second approximation function, and to apply the second approximation function to generate at least one interpolation output value to be used in approximating at least one output value of the overall function.

### FIELD OF THE INVENTION

The present invention relates to a non-homogeneous machine learning architecture for approximating an overall function. Aspects of the invention relate to a non-homogeneous machine learning architecture, to a method of training the non-homogeneous machine learning architecture, to a computer program product, and to a computer hardware device.

### BACKGROUND

In the field of Artificial Intelligence (AI) or Machine Learning (ML), Neural Networks (NN) play a particularly central role. These networks are computational frameworks that try to “learn” what should be the output of a given function, given a certain collection of inputs. Applications are vast, including pattern recognition (e.g. given a picture, recognise the person, the number plate, or other elements in it), function approximation (e.g. given certain state of the financial markets, obtain the value of a portfolio in risk calculations; or predict future values of financial market parameters), voice recognition, medicine, robotics, advertising, etc. The applications are nearly endless.

Once the NN has learnt the function at stake, the computational effort that the NN requires to provide an output given an input tends to be relatively low; i.e. predictions can be done relatively quickly and cheaply.

One of the key challenges of NNs is that the effort (i.e. time it takes to run and/or its monetary cost of IT infrastructure) of the learning step of a NN can be big. The reason is two folded. On one hand, it may require the evaluation of the function it is trying to learn an outstanding number of times (e.g. millions of times), and each evaluation can be difficult to obtain. On the other hand, the learning process requires the repeated calibration of the NN parameters via many iterations (e.g. millions of iterations), which can be slow and costly too.

Another key challenge of NNs lies in its accuracy. The output it provides is an approximation to the real value, should it be calculated. Building accurate NNs can be costly or very difficult in many cases.

In the art, homogeneous NN architectures—or machine learning architectures—are used in which the NN architecture includes a number of layers each including a number of processing nodes, where the same type of node is replicated throughout the entire architecture, and where weights associated with each node are learnt during a training process. It is considered that replicating the same type of node throughout the entire architecture can lead to, inter alia, processing efficiency.

It is against this background to which the present invention is set.

### SUMMARY OF THE INVENTION

According to one aspect of the present invention there is provided a non-homogeneous machine learning architecture for approximating an overall function as a composition of a first approximation function and a second approximation function. The non-homogeneous machine learning architecture comprises a neural network architecture for providing the first approximation function, the neural network architecture being configured to receive a plurality of input values for the overall function as an input to the first approximation function, and to apply the first approximation function to the received input values to generate a plurality of neural network output values. The non-homogeneous machine learning architecture comprises an interpolation architecture for providing the second approximation function, the interpolation architecture being configured to receive the plurality of neural network output values as an input to the second approximation function, and to apply the second approximation function to generate one or more interpolation output values to be used in approximating at least one output value of the overall function.

By ‘non-homogeneous’ is meant that the same processing structure is not adopted throughout the entire architecture. Instead, the present invention advantageously provides a machine learning architecture that includes both a neural network architecture portion and an interpolation architecture portion, in which the advantageous properties of each can be utilised and combined to provide an overall architecture that is beneficial over known architectures, in particular over known homogeneous architectures. Specifically, the non-homogeneous machine learning architecture of the present invention combines the ability of a neural network architecture to cope efficiently with high-dimensional input spaces, with the low computational demand and high degree of accuracy of an interpolation architecture in certain situations. The present invention therefore allows for a greatly reduced training time for computational approximation of complex functions and relationships compared with known homogeneous architectures, such as known neural network architectures, and also reduced execution time of the obtained, trained non-homogeneous architecture.

The number of the one or more interpolation output values may be less than the number of the plurality of neural network output values.

The number of the plurality of neural network output values may be less than the number of the plurality of input values.

The neural network architecture may comprise a plurality of concatenated layers, each layer having a dimension defined by a number of processing nodes within the respective layer. The dimension of an initial layer of the plurality of concatenated layers may be greater than or equal to the plurality of input values for the overall function. The dimension of a final layer of the plurality of concatenated layers may be both equal to the plurality of neural network output values and less than the dimension of the initial layer.

The neural network architecture may comprise a plurality of trained neural network parameters including a trained weight associated with each of the respective processing nodes. The interpolation architecture may comprise a plurality of trained interpolation parameters including a plurality of trained coefficients of the second approximation function. The trained neural network parameters and the trained interpolation parameters may have been previously determined as part of a training phase utilising forward and backward propagation through the non-homogeneous machine learning architecture.

The interpolation architecture may be configured to reduce the plurality of neural network output values to obtain a plurality of interpolation input values as the input to the second approximation function.

The interpolation architecture may be configured to perform a principal component analysis to reduce the plurality of neural network output values. The principal component analysis may comprise: selecting a subset of eigenvalues of a correlation matrix of the plurality of neural network output values; and, using eigenvectors corresponding to the subset of eigenvalues to obtain the plurality of interpolation input values.

The interpolation architecture may be configured to perform the principal component analysis when the number of the plurality of neural network output values has an order of magnitude of 10′ or greater.

The second approximation function may comprise a function expansion on a functional base formed by a series of orthogonal functions or an approximation to a function expansion on a functional base formed by a series of orthogonal functions, or combinations of those expansions or of their approximations.

The series of orthogonal functions may be one of the group comprising: sines, cosines, sines and cosines, Bessel functions, Gegenbauer polynomials, Hermite polynomials, Laguerre polynomials, Chebyshev polynomials, Jacobi polynomials, Spherical harmonics, Walsh functions, Legendre polynomials, Zernike polynomials, Wilson polynomials, Meixner-Pollaczek polynomials, continuous Hahn polynomials, continuous dual Hahn polynomials, a classical polynomials described by the Askey scheme, Askey-Wilson polynomials, Racah polynomials, dual Hahn polynomials, Meixner polynomials, piecewise constant interpolants, linear interpolants, polynomial interpolants, gaussian process based interpolants, spline interpolants, barycentric interpolants, Krawtchouk polynomials, Charlier polynomials, sieved ultraspherical polynomials, sieved Jacobi polynomials, sieved Pollaczek polynomials, Rational interpolants, Trigonometric interpolants, Hermite interpolants, Cubic interpolants, and Rogers-Szegö polynomials.

The overall function may be approximated as a composition of the first approximation function and the second approximation function. The generated at least one interpolation output value may be the approximation of the at least one output value of the overall function.

The overall function may be approximated as a composition of the first approximation function, the second approximation function, and a third approximation function, and the non-homogeneous machine learning architecture may comprise a neural network (or an additional homogeneous or non-homogenous machine learning) architecture for providing the third approximation function, the neural network (or an additional homogeneous or non-homogenous machine learning) architecture being configured to receive the generated at least one interpolation output value as an input to the third approximation function, and to apply the third approximation function to the received at least one interpolation output value to generate one or more of neural network (or an additional homogeneous or non-homogenous machine learning) output values as the approximation of the at least one output value of the overall function.

According to another aspect of the present invention there is provided training phase method for training a non-homogeneous machine learning architecture as described above. The neural network architecture comprises a plurality of training neural network parameters to be tuned during the training phase, and the interpolation architecture comprises a plurality of training interpolation parameters to be tuned during the training phase. The method comprises providing a plurality of training samples, each sample including a plurality of input training values, and one or more corresponding output training values, for the overall function. The method comprises repeating the steps of: performing a forward propagation step in which each of the plurality of training samples are executed by successively applying the first and second approximation functions to obtain an approximated value of each of the one or more outputs of the overall function; applying a cost function based on a difference between the approximated values and the respective training values of the one or more outputs of the overall function to determine a distance metric value; and performing a backward propagation step in which the training neural network parameters are updated in dependence on the determined distance metric value, until the determined distance metric value satisfies a predetermined condition or until the steps of forward propagation, applying a cost function and backward propagation have been performed a predefined number of times.

The method may further comprise: setting a plurality of anchor points in the input space of the second approximation function prior to performing the repeated steps of forward propagation, applying a cost function, and backward propagation. The forward propagation step may further comprise: approximating a value of the one or more outputs of the overall function at each of the plurality of anchor points using the plurality of neural network outputs received from the neural network architecture; and, determining updated values of the training interpolation parameters based on the approximated values of the one or more outputs of the overall function at each of the plurality of anchor points, wherein the one or more outputs of the overall function for each of the training samples in the forward propagation step is determined using the updated values of the training interpolation parameters.

In some embodiments, approximating the value of the one or more outputs of the overall function at each of the plurality of anchor points comprises: for each anchor point, approximating the value of the one or more outputs of the overall function using the training value for the one or more outputs of the overall function corresponding to the plurality of neural network outputs for at least one of the training samples.

In some embodiments, for each anchor point, approximating the value of the one or more outputs of the overall function comprises: selecting one or more of the training samples based on a proximity of the plurality of neural network outputs corresponding to each training sample relative to the anchor point, and using the training value for the one or more outputs of the selected training samples to approximate the value of the one or more outputs of the overall function.

In some embodiments, the method comprises, for each anchor point, selecting those training samples in which the value of the corresponding plurality of neural network outputs is within a predefined anchor point distance of the value of the anchor point for use in approximating the value of the one or more outputs of the overall function for the anchor point.

In some embodiments, the step of determining updated values of the training interpolation parameters comprises: updating the second approximation function; and extracting values of the coefficients of the updated second approximation function as the updated values of the training interpolation parameters.

In some embodiments, the backward propagation step comprises: updating the plurality of training samples, wherein for a given one of the training samples the training values are updated in dependence on a training sample distance between the plurality of neural network output values generated by the first approximation function using the input training values and a given one of the anchor points in order to reduce the training sample distance.

The second approximation function may comprise a function expansion on a functional base formed by a series of orthogonal functions or an approximation to a function expansion on a functional base formed by a series of orthogonal functions. The anchor points may be the zeros or the extrema points of each of orthogonal function, or a subset of the zeros or the extrema points.

In some embodiments, the method comprises determining at least one sub-function of the second approximation function, the at least one sub-function being a function of a subset of the plurality of neural network outputs, wherein in the forward propagation step the determined at least on sub-function is applied as the second approximation function.

The at least one sub-function may be determined using a sliding technique.

The method may further comprise using a completion technique to reduce the plurality of training samples used in the training phase.

The method may further comprise using a principle components analysis technique by itself or in combination with either one or both of the sliding technique and the completion technique.

According to another aspect of the present invention there is provided a computer program product storing instructions thereon that when executed by one or more electronic processors causes the one or more processors to perform the method described above.

According to another aspect of the present invention there is provided a computer hardware device arranged to implement the non-homogeneous machine learning architecture described above.

According to another aspect of the present invention there is provided an adapted non-homogeneous neural network architecture for approximating an overall function. The adapted non-homogeneous neural network architecture comprises a plurality of concatenated layers, each layer implementing part of the approximation of the overall function and each layer being arranged to receive a plurality of input values and to generate one or more output values. A first subset of the plurality of concatenated layers comprises a partial neural network architecture whereby the first subset is arranged to receive a plurality of subset input values, and to apply a first approximated function to generate a plurality of first subset outputs, A second subset of the plurality of concatenated layers comprises an interpolation architecture, whereby the second subset is arranged to receive the plurality of first subset outputs as an input, and to apply a second part of the overall function to generate at least one interpolated output value to be used to provide at least one output value of the overall approximated function.

According to another aspect of the present invention there is provided a training phase method for training a non-homogeneous machine learning architecture for approximating an overall function as a composition of at least a first approximation function and a second approximation function. The non-homogeneous machine learning architecture comprises a neural network architecture for providing the first approximation function and configured to receive a plurality of input values for the overall function, and comprises a plurality of training neural network parameters to be tuned during the training phase. The non-homogeneous machine learning architecture comprises an interpolation architecture for providing the second approximation function and configured to generate at least one output value to be used in approximating the overall function based on an output received from the neural network architecture, and comprises a plurality of training interpolation parameters to be tuned during the training phase. The method comprises providing a plurality of training samples, each sample including a plurality of input training values, and one or more corresponding output training values, for the overall function. The method comprises repeating the steps of: performing a forward propagation step in which each of the plurality of training samples are executed by successively applying at least the first and second approximation functions to obtain an approximated value of each of the one or more outputs of the overall function; applying a cost function based on a difference between the approximated values and the respective training values of the one or more outputs of the overall function to determine a distance metric value; and, performing a backward propagation step in which the training neural network parameters are updated in dependence on the determined distance metric value, until the determined distance metric value satisfies a predetermined condition or until the steps of forward propagation, applying a cost function and backward propagation have been performed a predefined number of times.

### BRIEF DESCRIPTION OF THE DRAWINGS

One or more embodiments of the invention will now be described, by way of example only, in which:

FIG. 1 illustrates a simple neural network (NN) architecture;

FIG. 2 illustrates a neuron or processing node of the NN architecture of FIG. 2;

FIG. 3 illustrates an alternative depiction of the neuron of FIG. 2;

FIG. 4 illustrates a learning rate of a weight of the neuron of FIG. 2;

FIG. 5 illustrates a stopping point in terms of iterations when training the weight of FIG. 4;

FIG. 6 illustrates a deep NN architecture;

FIG. 7 illustrates different components of a training module for training the NN of FIG. 6;

FIG. 8 illustrates different components of a parameter calibration module of the training module of FIG. 7;

FIG. 9(a) illustrates the steps of a method performed by the parameter calibration module of FIG. 8;

FIG. 9(b) further illustrates the forward and backward propagation engines of FIG. 8;

FIG. 9(c) further illustrates calculations performed in the forward and backward propagation engines of FIG. 8;

FIG. 10 illustrates different components of a supra-module for training hyper-parameters of the NN of FIG. 6;

FIG. 11 illustrates a linear interpolation framework or architecture;

FIG. 12 illustrates how an overall function may be approximated by the composition of a first approximation function and a second approximation function;

FIG. 13 illustrates how output values of a training set can be mapped to output values at particular anchor points, and then these mapped values at the particular anchor points can be used to approximate a function using an interpolation framework such as in FIG. 11;

FIG. 14 illustrates updating the output values of the training set of FIG. 13 during a training process;

FIG. 15 illustrates how input values of the training set of FIG. 13 can be updated towards one or more isovalue surfaces during the training process.

FIG. 16 illustrates a non-homogeneous machine learning architecture according to an embodiment of the present invention including a plurality of NN layers such as in the architecture of FIG. 6, and an interpolation framework layer such as in FIG. 11;

FIG. 17(a) illustrates forward and backward propagation for the interpolation framework layer of the architecture of FIG. 16;

FIG. 17(b) illustrates calculations performed in forward and backward propagation engines for the architecture of FIG. 16;

FIGS. 18 and 19 show plots of a cost function value against number of iterations, for both static and dynamic training sets, for the NN architecture of FIG. 6 compared to the non-homogeneous machine learning architecture of FIG. 16; and,

FIGS. 20 and 21 show plots of a cost function value against number of instances in a training set, for both static and dynamic training sets, for the NN architecture of FIG. 6 compared to the non-homogeneous machine learning architecture of FIG. 16.

### DETAILED DESCRIPTION

Neural Networks

Given a function

y=F(x₁,x₂,x₃, . . . ,xₙ)

that maps n input “x” values into an output “y” value, Neural Networks are combinations of linear and non-linear functions, that can be represented as

ŷ=\hat{F}(x₁,x₂,x₃, . . . ,xₙ)

that are calibrated to minimise the error between the function values provided by F and its Neural Network version \hat{F}.

To enable an easier understanding of the present invention NNs for functions whose output “y” is a one-dimensional number are explained. However, it is to be appreciated that everything said in relation to a one-dimensional function can be easily extended to higher-dimensional functions with no loss of generality. Also, the process that the NN may attempt to replicate may provide a binary (logic) output (e.g. does this picture contain a cat Y/N?); for this type of function, its NN counterpart \hat{F} provides a probability for each binary logic answer, to which a probability threshold is applied to compute the NNs answer (e.g. if \hat{F}>90%, then it is a cat); for these type of binary functions, everything explained here should be applied to the computation of the probability; i.e. F refers to the probability function.

Simple “Shallow” Neural Networks

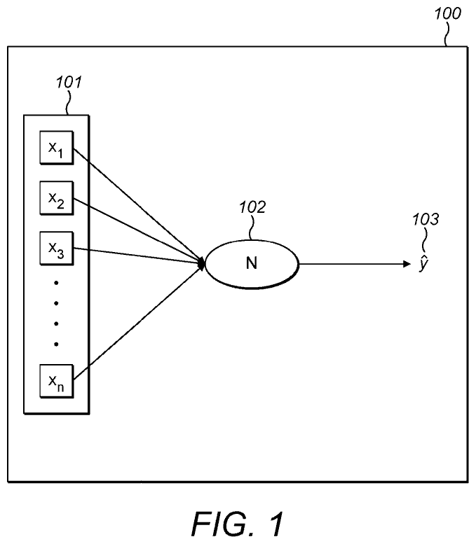

FIG. 1 illustrates a simple NN 100, composed of one single neuron (102). All n inputs 101 are fed into the neuron 102 that provides an output ŷ 103.

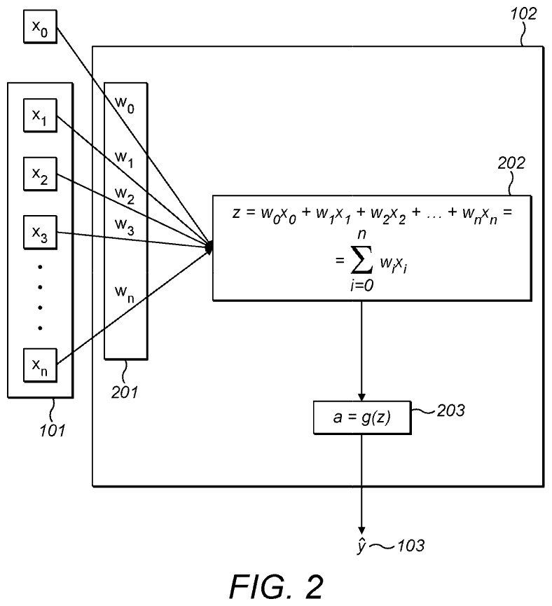

The neuron is described in more detail in FIG. 2. Firstly, then inputs 101 plus an independent value x₀=1 are multiplied by n+1 “w” values 201, which are then summed up, to compute a value “z” 202. Secondly, this value “z” is fed to an activation function g(⋅) to compute a value “a” 203. From the value a, the output ŷ 103 is calculated as ŷ=a.

As a note, the addition of the independent value x₀=1 is somewhat optional, but it is most often used in the art as it adds the extra functionality of having a “shift” term in the computation of z, at hardly any extra computational cost. This can increase the predictive capability of the NN.

Typical activation functions g(⋅) are the Sigmoid function, Hyperbolic Tangent function, Rectifier function (aka ReLU), Softplus function (aka SmoothReLU), Leaky ReLU, Parametric ReLU, Exponential ReLu (aka ELU), Linear or Unitary function (g(z)=z). Further details of these functions will be known to the skilled person and can also be found at hTTps://en,wikipedia.org/wiki/Activation function.

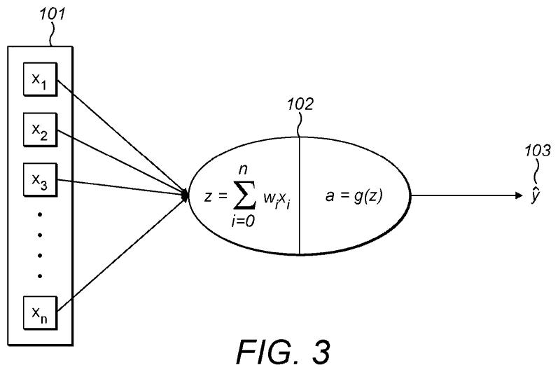

It is common in the art to represent a neuron as shown in FIG. 3. Sometimes, the activation function 203 is applied to the neuron inputs before the linear transformation 202.

Parameters and Hyper Parameters

The parameters that define the neuron are the n+1 “w” values 201.

The activation function used in 203 is typically considered a hyper parameter.

However, it is to be noted, that if the activation function depends on some parameters (e.g. g(z)=

$$ELU ( z ) = \{ \begin{matrix}b ( {e}^{z} - 1 ) ; z \leq 0 \\ z ; z > 0\end{matrix} \} ,$$

that depends on a parameter “b”), then that parameter “b” is considered a parameter of the NN).

This parameter vs. hyper parameter definition is important and will be explained further later. From now on, all the parameters of the NN will be referred to as “w” unless stated otherwise.

Training

Training the NN is that act of calibrating its parameters so the result is optimal. This is done for a gives sets of hyper parameters (i.e. NN architecture or structure). This calculation is also known in the art as “learning”.

For the NN to be trained, “m” sets of values (x₁, x₂, x₃, . . . , xₙ) are provided with each set having its corresponding y value. That is:

$$[ \begin{matrix}{x}_{1}^{( 1 )} \\ … \\ {x}_{n}^{( 1 )}\end{matrix} ] [ \begin{matrix}{x}_{1}^{( 2 )} \\ … \\ {x}_{n}^{( 2 )}\end{matrix} ] … [ \begin{matrix}{x}_{1}^{( m )} \\ … \\ {x}_{n}^{( m )}\end{matrix} ] , [ {y}^{( 1 )} , {y}^{( 2 )} , … , {y}^{( m )} ]$$

In the art, this is the so-called “training set”. The training set's pair (\vec{x}^{(j)}y^{(j)}) will be referred to as an instance or a sample of the training set.

For a given training set, the NN 100 provides in values for ŷ.

[\vec{y}⁽¹⁾,\vec{y}⁽²⁾, . . . ,\vec{y}^{(m)}]

For each instance “j” of the training set, its loss function “ [symbol] ” is defined, that represents a measurement of the distance between y(j) and \vec{y}^{(j)}. Typical loss functions used in the art are the quadratic function:

[symbol]

(\vec{y},y)=1/2(\vec{y}−y)²

or the cross-entropy function

[symbol]

(\vec{y},y)=−(y log\vec{y}+(1−y)log(1−\vec{y}))

but other loss functions can be used.

Then, a Cost function is defined, that measures how far apart [y⁽¹⁾, y⁽²⁾, . . . , y^{(m)}] is from [\vec{y}⁽¹⁾,\vec{y}⁽²⁾, . . . ,\vec{y}^{(m)})] as a whole. A commonly used Cost function is the average of the loss functions,

$$C = \frac{1}{m} {\sum }_{j = 1}^{m} ℒ ( {\hat{y}}^{( j )} , {y}^{( j )} )$$

In the art, this is the so-called ‘mean square function’. Other Cost functions could be used too.

The goal of the training calculation is to answer the following question: which set of parameters (represented as w) can be found that minimise the Cost function C? This question translates into finding the set of n+1 “w” parameters 201 that minimise the Cost function C.

As said, answering this question is known as “training the Neural Network”. When it is answered, it is said that the NN has learnt or has been trained.

A widely used method to train the NN is the so called Gradient Decent method, which is explained here. However, other methods could be used too without loss of generality.

Gradient Descent

The training process takes place through an iterative looping process, where, in each iteration, the parameters w are updated. This is done in a loop until some end condition (e.g. confidence level) is satisfied such that the Cost function ‘C’ has been minimised.

The training process starts by, at the beginning of loop 1, giving each of the NN parameters w certain starting values; they are typically picked randomly. In each iteration of the loop, each of the parameters wᵢ is updated as follows:

wᵢ:=wᵢ−αdwᵢ

where

$${dw}_{i} = \frac{\partial C}{\partial {w}_{i}}$$

Where α, the so called “learning rate”, is a hyper parameter of the NN, ∂C=change in the Cost function and ∂wᵢ=change in parameter wᵢ.

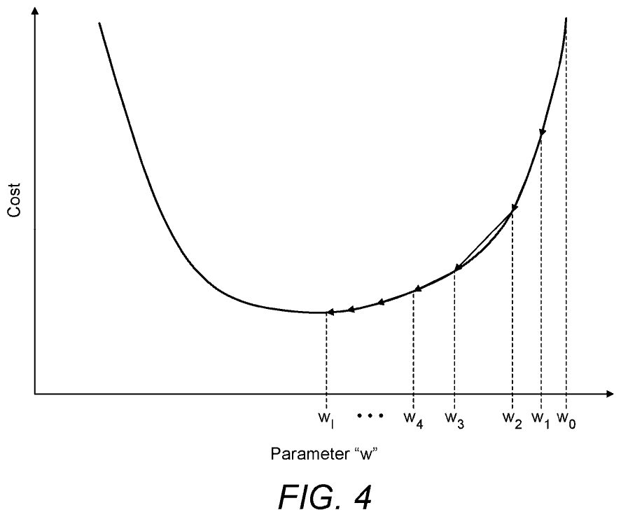

This process is graphical illustrated in FIG. 4. A given parameter wᵢ starts at a given value. dwᵢ is then computed and wᵢ is updated to a new value. The Cost function C should decrease with the new values of the parameter w. This process is repeated lots of times, “l” times, so that the Cost function C reaches a minimum value, or a value very close to its minimum.

There are several ways to stablish when this process stops; i.e. to set I. A simple one is by setting it to a fixed given number. Another method uses the fact that, as the point of minimum C is approached, it is known that:

$$\frac{\partial C}{\partial {w}_{i}} \approx 0$$

That also means that the parameters are hardly updated for subsequent loops (iterations). Hence, the computer calculation can be set so that when the parameters are updated by less than a certain value (e.g. 0.1% of their value), then the learning process stops. An alternative method comprises monitoring in each loop the value of C, so that when it is hardly changed by the iteration, it can be concluded that the Cost function C must have reached a minimum.

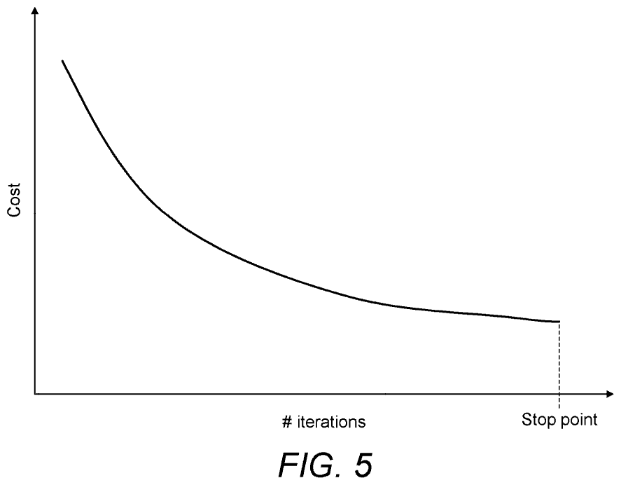

This idea is depicted in FIG. 5.

In each loop of the training process, the derivative of the Cost function with respect to each of the parameters must be computed. In particular, in the sample in which the Cost function is the average of the Loss function across the training set, and denoting [symbol] ^{(j)}= [symbol] (\vec{y}^{(j)}, y^{(j)})),

$$\frac{\partial C}{\partial {w}_{i}} = \frac{1}{m} {\sum }_{j = 1}^{m} \frac{\partial {ℒ}^{( j )}}{\partial {w}_{i}}$$

Where

$$\frac{\partial {ℒ}^{( j )}}{\partial {w}_{i}} = \frac{\partial {ℒ}^{( j )}}{\partial {a}^{( j )}} \frac{\partial {a}^{( j )}}{\partial {z}^{( j )}} \frac{\partial {z}^{( j )}}{\partial {w}_{i}}$$

noting that a=\vec{y}, and that for each training sample “j” a^{(j)}=\vec{y}^{(j)} is obtained.

Using as an illustrative example the case in which the Loss function is the cross-entropy function and the activation function is the Sigmoid function, then

$$\frac{\partial {ℒ}^{( j )}}{\partial {a}^{( j )}} = - \frac{{y}^{( j )}}{{a}^{( j )}} + \frac{1 - {y}^{( j )}}{1 - {a}^{( j )}}$$

$$\frac{\partial {a}^{( j )}}{\partial {z}^{( j )}} = {a}^{( j )} ( 1 - {a}^{( j )} )$$

$$\frac{\partial {a}^{( j )}}{\partial {w}_{i}} = {x}_{i}$$

This computation can be done for each training sample “j”, working backwards in the calculation. For each sample “j” of the training set,

$$\frac{\partial {ℒ}^{( j )}}{\partial {w}_{i}}$$

can be computed and then averaged to obtain

$$\frac{\partial C}{\partial {w}_{i}} .$$

With these values, the parameter values are updated as per wᵢ:=wᵢ−αdwᵢ, and then the next iteration of the looping process commences with the new values of the “w” parameters. As said previously, the computation iterates through this loop until it is satisfied that it has reached a minimum value of the Cost function.

Forward and Backward Propagation of the NN

In the art, the computation to calculate \vec{y} is called “forward propagation” and the computation to calculate the collection of dmᵢ, is called “backward propagation”,

Complex “Deep” Neural Networks

The NN explained above is the simplest NN; it contains only one layer and one neuron. More complex NNs can be created by concatenating them as shown and described in this section. As the NNs become more complex, it is said in the art that they become “deeper” NNs. Simple NNs are described as “shallow” and complex ones as “deep”.

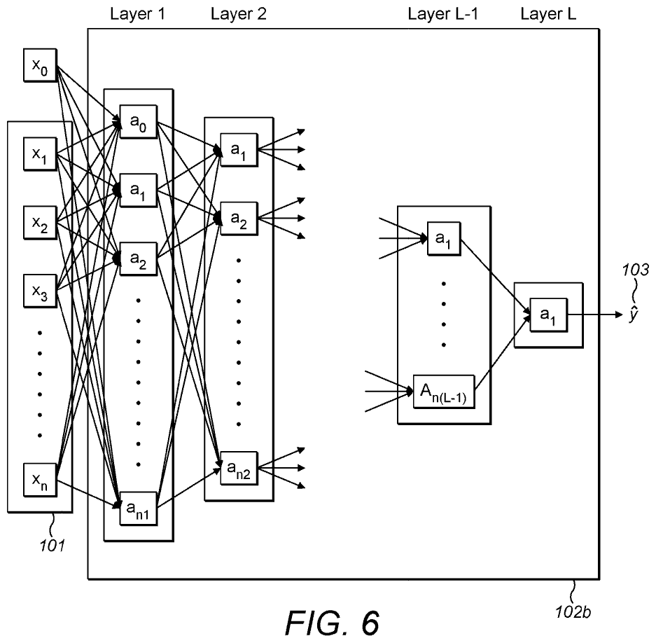

A deep NN consists of a plurality of neurons stacked on top of each other in what it is called a “layer”, and then, often, multiple layers are concatenated, one after another. This is depicted schematically in FIG. 6.

The NN 102b represented in FIG. 6 has L layers, each of them with a plurality of neurons. The first layer has n^{[1]} neurons, the second layer has n^{[2]} neurons, etc. The number of layers L, and the number of neurons in each layer {n^{[1]}, n^{[2]} , . . . , n^{[L]}} are hyper parameters of the NN.

A note on notation: a number in a square bracket represents the layer number, in a circular bracket represents an instance of the training set, and a number without a bracket represents a neuron inside a layer. For example, ξ₂^{(3)[6]} represents the value of variable ξ in the 2^{nd} neuron of the 6^{th} layer, for the 3^{rd} instance of the training set.

Each neuron has a structure as explained before. The inputs to a given neuron in layer “l” are the outputs of the n^{[l-1]} neurons of the previous layer,

$${\{ {a}_{i}^{[ l - 1 ]} \}}_{i = 1}^{{n}^{[ l - 1 ]}} .$$

Those inputs are multiplied for a number of parameters wᵢ^{[l]} and then summed up into a z variable. For example, for neuron j in layer l.

$${z}_{j}^{[ l ]} = {\sum }_{i = 0}^{{n}^{[ l - 1 ]}} {w}_{i}^{[ l ]} {a}_{i}^{[ l - 1 ]}$$

Notes: For the first layer (i.e. [l=1]), the inputs to its neurons are the input data 101; hence, this notation also works for l=1 by making aᵢ^{[0]}=xᵢ. Also, note that i=0 represents an independent element; that is, a₀=1 always.

Once the variable zⱼ^{[l]} has been computed, the activation function of that layer g^{[l]} (⋅) is applied to the z parameters, obtaining the output of the neuron j in layer l

aⱼ^{[l]}=g^{[l]}(zⱼ^{[l]})

To be noted that, as said, the activation function could be applied to the inputs before the computation of the z parameters is carried out; this case is less frequent in the art, but it could happen. Also, an activation function could be applied before z is computed as well as after.

The number of layers L, number of neurons in each layer {n^{[1]}, n^{[2]}, . . . , n^{[L]}} and the activation function in each layer {g^{[1]}, g^{[2]}, . . . , g^{[L]}} are hyper parameters of the NN. The collection of wᵢ^{(j)[k]}, as well as any parameter that the activation functions may have or any parameter that is updated in each iteration of the learning loop, are considered parameters of the NN.

Typically, each layer has one single activation function. However, the NN could be also designed so that different neurons in a given layer have different activation functions.

Training

The training of deep NNs follows an equivalent procedure to the one explained above for a simple shallow NN.

In a forward propagation, the NN computes a value 9 for each of the in input samples

$$[ \begin{matrix}{x}_{1}^{( 1 )} \\ … \\ {x}_{n}^{( 1 )}\end{matrix} ] [ \begin{matrix}{x}_{1}^{( 2 )} \\ … \\ {x}_{n}^{( 2 )}\end{matrix} ] … [ \begin{matrix}{x}_{1}^{( m )} \\ … \\ {x}_{n}^{( m )}\end{matrix} ]$$

Hence it computes

[ŷ⁽¹⁾,ŷ⁽²⁾, . . . ,ŷ(m)]

This is done computing, in each neuron

$${z}_{j}^{( k ) [ l ]} = {\sum }_{i = 0}^{{n}^{[ l - 1 ]}} {w}_{i}^{[ l ]} {a}_{i}^{( k ) [ l - 1 ]} and {a}_{j}^{( k ) [ l ]} = {g}^{[ l ]} ( {z}_{j}^{( k ) [ l ]} )$$

This calculation is done layer by layer, and neuron by neuron, for each instance of input sample k.

It starts by initialising the parameters of the NN to, typically, some random values. Then, it starts with layer 1, neuron 1 and instance 1, computing z₁^{(1)[1]}, followed by a₁^{(1)[1]}. Then the computation moves to the next neuron and computes z₂^{(1)[1]} and a₂^{(1)[1]}, continuing in the first layer until zₙ_{^{[1]}}^{(1)[1]} and aₙ_{^{[1]}}^{(1)[1]} are computed. Then it moves to the second layer and computes z₁^{(1)[2]} and a₁^{(1)[2]}, followed by z₂^{(1)[2]} and a₂^{(1)[2]} continuing up to zₙ_{^{[2]}}^{(1)[2]} and aₙ_{^{[2]}}^{(1)[2]}. Then it moves to the next layer and does the same computation. This is done up to the last layer, that computes zₙ_{^{[L]}}^{(1)[L]} and aₙ_{^{[L]}}^{(1)[L]}. Then, ŷ⁽¹⁾=aₙ_{^{[L]}}^{(1)[L]}.

Then, the computation moves to the second instance of the input sample, and computes ŷ⁽²⁾ as explained in the previous paragraph.

This is repeated through all the instance of the input sample. The outcome of the forward propagation is, hence, the collection of values

[ŷ⁽¹⁾,ŷ⁽²⁾, . . . ,ŷ^{(m)}]

Next, similarly to the example of the simple NN, the loss value for each instance of the input sample is computed, followed by the cost value

$$C = \frac{1}{m} {\sum }_{j = 1}^{m} ℒ ( {\hat{y}}^{( j )} , {y}^{( j )} )$$

Following the forward propagation, the backwards propagation is carried out. In it, the changes to each of the NN parameters are computed, so that at the end of it, they are updated

$${w}_{i} := {w}_{i} - α d {w}_{i} where d {w}_{i} = \frac{\partial C}{\partial {w}_{i}}$$

so that the final parameters minimise the Cost function. Similarly to the simple case shown above, the

$$\frac{\partial C}{\partial {w}_{i}} = \frac{1}{m} {\sum }_{j = 1}^{m} \frac{\partial {ℒ}^{j}}{\partial {w}^{i}}$$

and each term

$$\frac{\partial {ℒ}^{j}}{\partial {w}^{i}}$$

is computed applying the chain rule layer by layer, and neuron by neuron.

This iterative process (forward propagation, backward propagation and parameters update) is repeated many times, until the end condition is satisfied, namely that a minimum of the Cost function has been approached. When so, the learning process has finished, the parameters found are the final parameters, and it is said that the NN has learnt or has been trained.

A Modular View of the Learning Computation

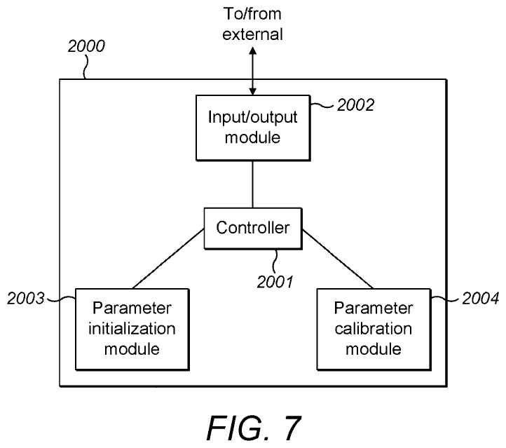

A training module 2000 of a NN in a schematic view is shown in FIG. 7. The NN training module 2000 is comprised of a Controller 2001, an Input/Output module 2002, a Parameter Initialisation module 2003 and a Parameter Calibration module 2004. When the Training starts, the Input/Output module 2002 receives the hyper parameters of the Neural Network (i.e, the architecture of the NN; details of parameters vs hyper parameters are discussed later) as well as the “m” training samples described above (a variation of this training process comprises computing the training sample “on the fly” and this is also described in subsequent sections). Module 2003 initialises the NN parameters to, typically, random values distributed according to a normal Gaussian distribution (however, it must be noted the initialisation may be done to other distributions or values that, driven by the know-how and experience of the skilled individual, may consider to work better for the NN hyper parameters and problem to be solved at hand; this learning process is typically done via an empirical trial-and-error process by the skilled individual. This degree of freedom does not have any relevant impact in the present invention as is explained later).

After the parameters have been initialised, module 2004 finds the optimal set of parameters for the NN. Once found, the controller 2001 passes them to the Input/Output module 2002 that passes them to the external environment (to configure the NN).

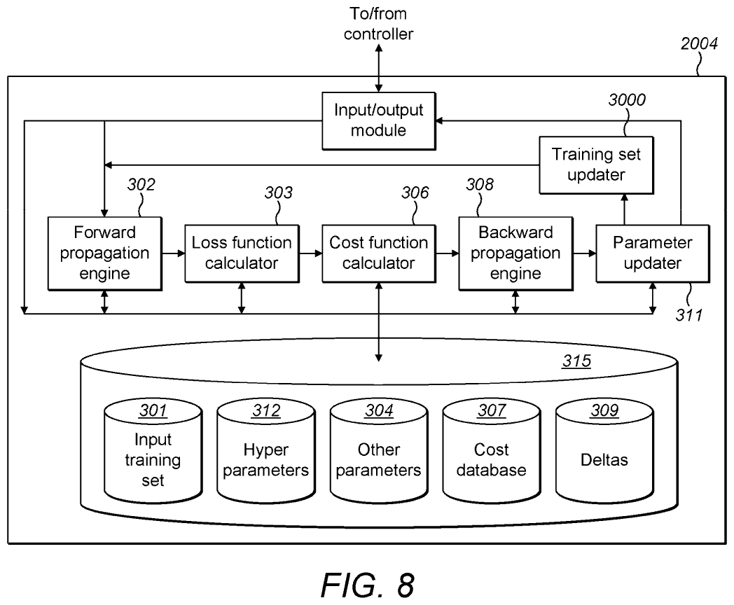

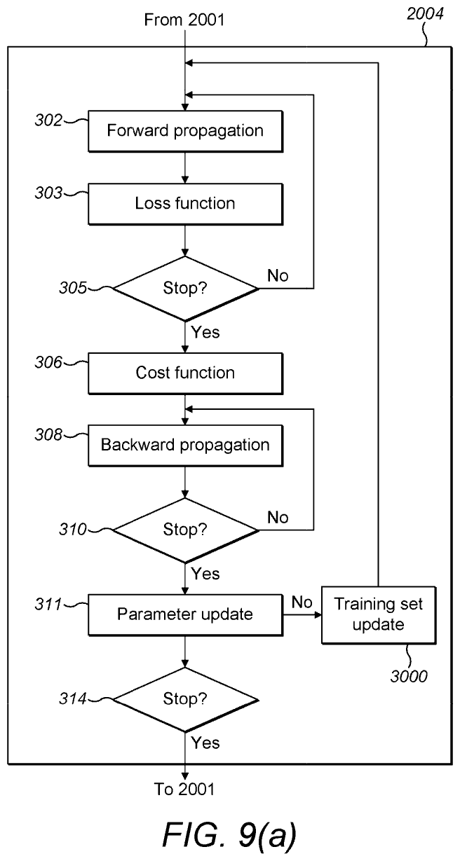

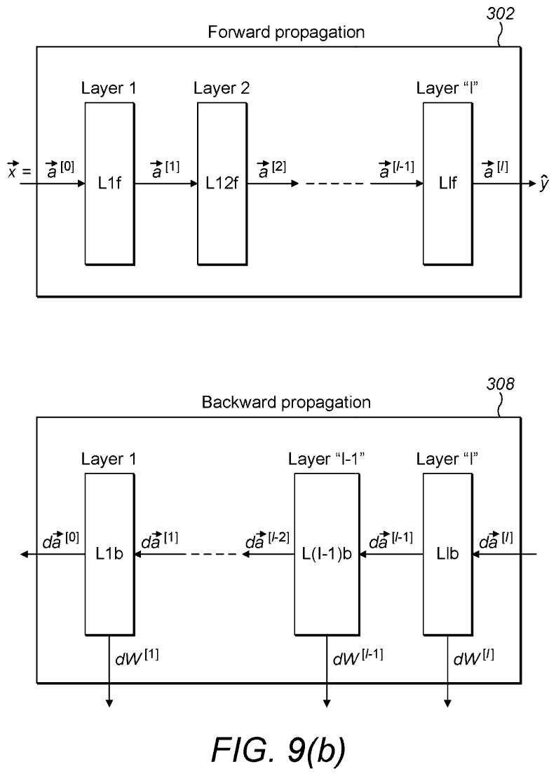

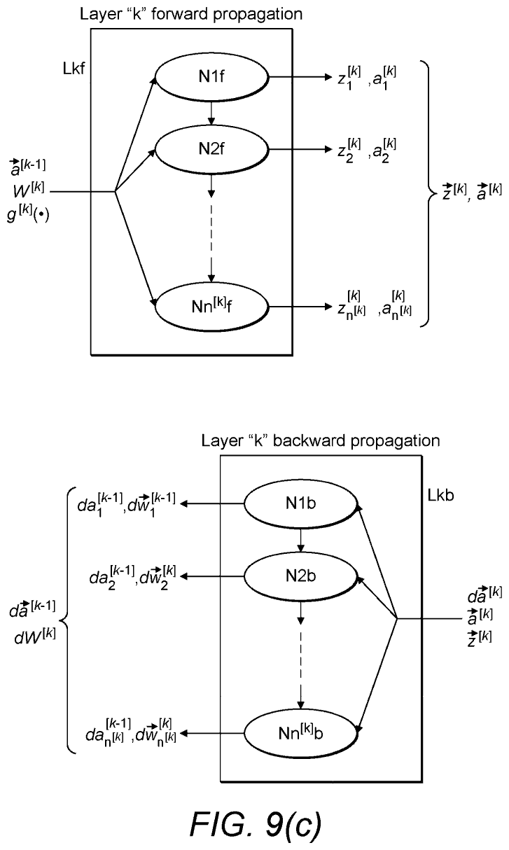

The Parameter Calibration module 2004 is now described in greater detail with reference to FIGS. 8, 9a, 9b and 9c.

FIG. 8 shows the structure of the Parameter Calibration module 2004 and FIG. 9a shows the method of operation of the Parameter Calibration module. Referring to these figures it can be seen that Module 2004 receives from the controller 2001 the NN hyper parameters (e.g. number of layers, number of neurons in each layer, activation function in each layer, etc.), the initialised parameters (e.g, w₀, w₁, w₂, . . . , wₙ) and the input training sample.

$$[ \begin{matrix}{x}_{1}^{( 1 )} \\ … \\ {x}_{n}^{( 1 )}\end{matrix} ] [ \begin{matrix}{x}_{1}^{( 2 )} \\ … \\ {x}_{n}^{( 2 )}\end{matrix} ] … [ \begin{matrix}{x}_{1}^{( m )} \\ … \\ {x}_{n}^{( m )}\end{matrix} ] , [ {y}^{( 1 )} , {y}^{( 2 )} , … , {y}^{( m )} ]$$

The input training sample (or training set) is stored in a data store 315 and, more specifically, as an input training data set 301. The NN parameters w and the hyper parameters are also stored in the data store 315 and, more specifically, as a set of hyper parameters 312.

Then, the first instance of the input sample (x₁⁽¹⁾, x₂⁽¹⁾, . . . , xₙ⁽¹⁾; y⁽¹⁾), the parameters w and the hyper parameters are passed to module 302, where the forward propagation is carried out. In this forward propagation, for a given set of inputs (x₁, x₂, . . . , xₙ) an output ŷ is calculated; hence, module 302 computes ŷ¹ and outputs it. The values y^{l} and ŷ¹ are stored in the data store 315 as other parameters 304, as well as all the values of the intermediate steps in the forward propagation (the z⁽ⁱ⁾ and the a⁽¹⁾ in each layer and neuron).

Next, the loss function calculator 303 computes the loss value [symbol] for that instance of the input training sample; for example,

[symbol]

⁽¹⁾= [symbol] (ŷ⁽¹⁾,y⁽¹⁾)=1/2(ŷ⁽¹⁾=y⁽¹⁾)²

The [symbol] ⁽¹⁾ value is stored in the data store 315 as part of the other parameters 304.

Next, the Parameter Calculation module 2004 decides whether to compute another iteration of the loop or not. If all 9 values that correspond to all the m instances of the input training sample have been computed, the Parameter Calculation module 2004 stops the loop. Otherwise, it goes through another occurrence of the loop. In this new occurrence, the process as shown in FIG. 9a picks the next instance from the input training set 301 stored in the datastore 315, then the forward Propagation Engine 302 computes its ŷ, the Loss Function Calculator 303 computes its loss value, all the computed information is stored in the data store 315 with the other parameters 304. The Parameter Calculation module 2004 decides at Step 305 again if another recurrence of the loop is required or not. Once all the m instances of the input training sample have been processed in this looping process, the Parameter Calculation module 2004 stops the loop.

Next, the Cost Function module 306 computes the Cost function at Step 306 of the training sample for the parameters used in the Forward Propagation Engine 302 (e.g. w₀, w₁, w₂, wₙ). An example of Cost function commonly used is

$$C = \frac{1}{m} {\sum }_{j = 1}^{m} ℒ ( {\hat{y}}^{( j )} , {y}^{( j )} )$$

The value of the Cost function is stored in the data store 315 within the Cost Database 307.

Next, the information stored in the input training set 301 and the other parameters 304 for the first instance of the training sample is selected. This information is passed to the Backward Propagation Engine 308, where the NN backwards propagation calculation is carried out. The Backward Propagation Engine 308 computes the “deltas” of the parameters for the first instance of the training set (dw₀⁽¹⁾, dw₁⁽¹⁾, dw₂⁽¹⁾, . . . , dwₙ⁽¹⁾). These deltas are then stored in the data store in a deltas data store 309. The Parameter Calculation Module 2004 then decides at step 310 if going through another concurrence of the loop is required. If the deltas of all tri instances of the training set have been computed, the Parameter Calculation Module 2004 at Step 310 stops the loop; otherwise, the process loops back and continues with the next occurrence. In the next occurrence, the next instance of the training sample is selected and its respective deltas are computed by the Backward Propagation Engine 308. Once all instances of the training set have been used for a background calculation in the Backward Propagation Engine 308 and stored, the Parameter Calculation Module 2004 stops the looping at Step 310.

Next, the Parameter Updater 311 updates the NN parameters as follows:

wᵢ:=wᵢ−αdwᵢ

The data store 309 contains a delta for each of the parameters i, and training set instances j, dwᵢ^{(j)}. With that information, module 311 computes the deltas for each parameter, dwᵢ as, for example, the average across the m training samples. Then, the parameters wᵢ are updated by module 311. Both the old and new parameters (i.e. before and after the update) are stored in the data store as hyper parameters 312.

Next, the Parameter Calculation Module 2004 decides at Step 314 whether to stop the training process or not. That decision can be based on several parameters. For example, the Parameter Calculation Module 2004 may decide at Step 314 to stop the training process after a given number of interactions through the learning loop (by learning loop it is meant the computation just described of forward propagation 302, loss function 303, Cost function 306, backwards propagation 308 and parameters update 311). Also, the Parameter Calculation Module 2004 may access at Step 314 the cost values stored in the cost database 307 and stop when the Cost function hardly changes (e.g. less than 0.01% of its value) in adjacent iterations. Also, it may decide to assess the changes of the parameters themselves and stop when they hardly change (e.g. when the parameter that changes most has a change of less than 0,01% of its value) in adjacent iterations. Also, this assessment could be carried out using the last two values of the cost value or NN parameters, or the last three, or four, etc. Each of these options is a hyper parameter of the NN.

The idea is that the Parameter Calculation Module 2004 uses at Step 314 a metric to assess if the parameters change any more in a significant manner by further iterations. When they do not change any more in a significant manner, it is said that the NN has learnt or has been trained.

When the Parameter Calculation Module 2004 determines at Step 314 that NN has learnt, the learning looping calculation stops. Otherwise, it continues again to another iteration of the learning loop (described above), but with the updated parameters this time.

Note: the training set updater 3000 is optional, and will be described later in the document.

The number of iterations in the learning loop is referred to as l.

Forward and Backward Propagation

The Forward Propagation module 302 and Backward Propagation module 308 are further explained in FIG. 9b.

For ease of illustration, the following vectorised and matrix notation is used in an exemplary example which considers the first layer of a neural network. For easy of illustration, in this example it is assumed that the input space has six variables (x₁, x₂, . . . , x₆) (i.e. n=6) and the first layer has two neurons (i.e. n^{[1]}=2)). In this case, there are 6+1 w parameters for each neuron of the first layer and the matrix is built as follows:

$${W}^{[ 1 ]} = [ \begin{matrix}{w}_{0 , 1}^{[ 1 ]} & {w}_{0 , 2}^{[ 1 ]} \\ {w}_{1 , 1}^{[ 1 ]} & {w}_{1 , 2}^{[ 1 ]} \\ {w}_{2 , 1}^{[ 1 ]} & {w}_{2 , 2}^{[ 1 ]} \\ {w}_{3 , 1}^{[ 1 ]} & {w}_{3 , 2}^{[ 1 ]} \\ {w}_{4 , 1}^{[ 1 ]} & {w}_{4 , 2}^{[ 1 ]} \\ {w}_{5 , 1}^{[ 1 ]} & {w}_{5 , 2}^{[ 1 ]} \\ {w}_{6 , 1}^{[ 1 ]} & {w}_{6 , 2}^{[ 1 ]}\end{matrix} ]$$

Generalising this, W^{[l]} refers to the w parameters in the l-th layer of the neural network, and w_{i,j}^{[1]} refers to the calibrating parameter w that is the connection from neuron “i” in layer “l−1” to neuron “j” in layer “l” (the input layer can be seen as a “layer 0”). Hence, “i” ranges from 0 to n^{[l-1]} (note, it starts from 0 because the w₀ connects the independent term a₀^{[1]}=1), and “j” ranges from 1 to n^{[1]}.

It is to be appreciated that the term ‘parameter’ has been used in this document in a general sense to cover any variable. It is known that in the art of Neural Networks, the term ‘parameter’ is normally considered to only be referring to any Neural Network parameter which is updated during the learning loop or any hyper parameter of the neural network. Such parameters define the neural network. Under this construction the Neural Network parameters would be variable parameters of the NN and hyper parameters. This would exclude static parameters such as a and z for example. Having appreciated this, the following refers to all values as parameters.

Also, in the example used, we can vectorise the a parameters by defining the vector

$${\vec{a}}^{[ 1 ]} = [ \begin{matrix}{a}_{0}^{[ 1 ]} = 1 \\ {a}_{1}^{[ 1 ]} \\ {a}_{2}^{[ 1 ]}\end{matrix} ]$$

Generalising, aᵢ^{[l]} refers to the ‘a’ parameter computed by the i-th neuron in the l-th layer. Similarly to \vec{a}^{[l]}, we can define the vector VI for the z parameters in layer “l”.

Similar definitions can be done for their changes in each learning iteration, hence defining dW and d\vec{a}. For example:

$$d {W}^{[ 1 ]} = [ \begin{matrix}d {w}_{0 , 1}^{[ 1 ]} & d {w}_{0 , 2}^{[ 1 ]} \\ d {w}_{1 , 1}^{[ 1 ]} & d {w}_{1 , 2}^{[ 1 ]} \\ d {w}_{2 , 1}^{[ 1 ]} & d {w}_{2 , 2}^{[ 1 ]} \\ d {w}_{3 , 1}^{[ 1 ]} & d {w}_{3 , 2}^{[ 1 ]} \\ d {w}_{4 , 1}^{[ 1 ]} & d {w}_{4 , 2}^{[ 1 ]} \\ d {w}_{5 , 1}^{[ 1 ]} & d {w}_{5 , 2}^{[ 1 ]} \\ d {w}_{6 , 1}^{[ 1 ]} & d {w}_{6 , 2}^{[ 1 ]}\end{matrix} ] , d {\vec{a}}^{[ 1 ]} = [ \begin{matrix}d {a}_{0}^{[ 1 ]} = 0 \\ d {a}_{1}^{[ 1 ]} \\ d {a}_{2}^{[ 1 ]}\end{matrix} ]$$

With these definitions, and also defining the input vector as a natural extension of the above terminology,

$$\vec{x} = [ \begin{matrix}{x}_{0} = 1 \\ {x}_{1} \\ {x}_{2} \\ {x}_{3} \\ {x}_{4} \\ {x}_{5} \\ {x}_{6}\end{matrix} ] , or {\vec{a}}^{[ 0 ]} = [ \begin{matrix}{a}_{0}^{[ 0 ]} = {x}_{0} \\ {a}_{1}^{[ 0 ]} = {x}_{1} \\ {a}_{2}^{[ 0 ]} = {x}_{2} \\ {a}_{3}^{[ 0 ]} = {x}_{3} \\ {a}_{4}^{[ 0 ]} = {x}_{4} \\ {a}_{5}^{[ 0 ]} = {x}_{5} \\ {a}_{6}^{[ 0 ]} = {x}_{6}\end{matrix} ]$$

With this notation, the forward and backward propagation modules can be illustrated as shown in FIG. 9b.

The Forward Propagation module 302 starts with \vec{x}, or \vec{a}. In the layer 1 (module L1f), each neuron computes its z and a values, given W^{[1]} and its activation function g^{[1]}(⋅) , that are taken from the data store of hyper parameters 312, collectively referred to as \vec{z}^{[1]} and \vec{a}^{[1]}. \vec{z}^{[1]} and \vec{a}^{[1]} are stored in the data store of other parameters 304. Then, similarly, the next layer 2 (module L2f) takes \vec{a}^{[1]} and, given W^{[2]} and its activation function g^{[2]}(⋅), that are taken from data store of hyper parameters 312, computes \vec{z}^{[2]} and \vec{a}^{[2]}, that are stored in the data store of other parameters 304. The calculation continues on this manner sequentially, layer by layer, until it gets to the last layer “l”. \vec{a}^{[1]}, calculated by that layer, is ŷ.

The backward propagation module 308 starts computing d\vec{a}^{[l]}. Then, module Llb computes dW^{[l]} for the first layer “l” (note, it is first layer in the backward propagation, but its counterpart in the forward propagation 302 was the first layer). d\vec{a}^{[l]} and dW^{[l]} are stored in the data store of deltas 309. d\vec{a}^{[1]} is passed to the next layer (module “L(l−1)b”), that computes d\vec{a}^{[l-1]} and dW^{[1]}, which are stored in the data store 315. d\vec{a}^{[l-1]} is passed on to the next layer, and the calculation continues like this layer by layer, until the last layer (which is the counterpart of the first layer in the forward propagation) is reached, where d\vec{a}^{[0]} and dW^{[1]} are compute and stored.

Single Layer Forward and Backward Propagation

FIG. 9c shows in more detail the calculations performed by each layer in the forward and backward propagation, for a generic layer “k”.

In the forward calculation for a, the k-th layer of the NN is shown in module Lkf. In it, the computation starts with the first neuron in module N1f, which computes z₁^{[k]} and a₁^{[k]}, using \vec{a}^{[k-1]}, as well as the first row of the matrix W^{[k]} and g^{[k]}(⋅). Then it moves to the second neuron in module N2f, which computes z₂^{[k]} and a₂^{[k]}, using \vec{a}^{[k-1]}, the second row of the matrix W^{[k]} and g^{[k]}(⋅). Module Lkf continues sequentially up to the last neuron, Ln^{[k]}f, which computes zₙ_{^{[K]}}^{[k]} and \vec{a}ₙ_{^{[k]}}^{[k]}, using \vec{a}^{[k-1]}, the last row of the matrix W^{[k]} and g^{[k]}(⋅). The computed vectors \vec{z}^{[k]} and \vec{a}^{[k]} are passed to data store of other parameters 304 then stored.

The backward for layer “k” calculation is computed by module Lkb. The computation starts with the first neuron in module N1b, that calculates daᵢ^{[k-1]} and d\vec{w}₁^{[k]} taking as inputs daᵢ^{[k]}, z₂^{[k]} and a₁^{[k]}. Then, the second neuron in module N2b computes da₂^{[k-1]} and d\vec{w}2^{[k]} taking as inputs da₂^{[k]}, z₂^{[k]} and a₂^{[k]}. The calculation continues like this, sequentially, until the last module Ln^{[k]}b computes daₙ_{^{[k]}}^{[k-1]} and d\vec{w}ₙ_{^{[k]}}^{[k]}, taking as inputs daₙ_{^{[k]}}^{[k]}, zₙ_{^{[k]}}^{[k]} and aₙ_{^{[k]}}^{[k]}. The computed vectors and matrix d\vec{a}^{[k]} and dW^{[K]} are then stored.

Dynamic Computation of the Training Set

In the NN explained above, it is assumed that the training set contains in instances, and that the same training sample is used in every iteration of the learning loop. However, in an alternative version of NN, the training set can be modified in each iteration. This is illustrated in FIGS. 8 and 9 with the training set updater 3000. In such a NN, when a new iteration is started, the training set updater 3000 generates new training instances to be added to the training set.

There are several ways these instances are used by the learning computation in the Parameter Calculation Module 2004. In each iteration of the learning loop, it may use only the newly generated instances at the end of the previous loop. Alternatively, it may use the union of the old plus the newly generated instances, or a subset of them. How the existing and newly generated instances are utilised is a hyper parameter of the NN.

The ways in which the new instances are generated by the training set updater 3000 can be very diverse. For example, if the input training set represents pictures, the training set updater 3000 can create variations of those pictures. If the input training set represents input-output values of the function F, the training set updater 3000 may generate new input-output values based on some information gathered during iterations of the learning loop.

Other Variations of NN

It must be understood that a typical NN has been described, but there are many modifications of this in the art. A good comprehensive list of variations can be found at https://towardsdatascience.com/the-mostly-complete-chart-of-neural-networks-explained-3fb6f2367464

It would be practically impossible to describe all of these variations in detail. Accordingly it is to be understood that, in the present specification, the term ‘NN’ refers to all and any type of NN known in the art.

Parameters Vs. Hyper Parameters

On one hand, the goal of the training computation of a NN is to find the optimal value for its parameters, which have been symbolised in general as the w parameters. As said, it must be noted that those parameters may include parameters embedded in the activation functions or other parameters. In general, by the term “NN parameter” it is meant any parameter that is updated in each iteration of the training loop.

On the other hand, the NN is defined by a number of hyper parameters. Those include the number of layers, number of neurons in each layer, activation functions in each layer and neuron, the loss function, the Cost function, the learning rate for the update of parameters, the stopping point for the learning iterative loop, etc. Sometimes those hyper parameters are referred to in the art as the “architecture” or the “structure” of the NN.

The Goal of a NN Learning Calculation

When a NN has already learnt, it is said that it has found the function P that can be taken as a substitute for F; in other words, P has been calibrated. By “calibrated” it is meant that the parameters of the forward propagation in module 302 have been optimised. The function P is the forward propagation function in module 302.

The computational challenge:

As said, the goal of the learning or “training” calculation of the NN is to find an \hat{F} so that

\hat{F}(x₁,x₂,x₃, . . . ,xₙ)≈F(x₁,x₂,x₃, . . . ,xₙ)

The following difficulties arise:
1. Precision—the calibrated NN function \hat{F} is generally an approximation to F. Hence, when \hat{F}(x₁, x₂, x₃, . . . , xₙ) is computed, it will typically give an error compared to the true value F(x₁, x₂, x₃, . . . , xₙ). The smaller that error, the better and more useful the trained function \hat{F} will be. This can be difficult to obtain to the extent that, in many cases, the \hat{F} may not be of practical use for the application at hand if the accuracy is not good enough. As a result, the more accurate \hat{F} is relative to F, the better the NN is. Consequently, changes to a NN that can increase the precision of \hat{F} relative to F are beneficial.
2. Number of learning iterations—The training computation will carry out “l” iterations. This number tends to be a very large number, up to many thousands or millions. This creates a computational challenge, as the training computation could take so long, or could require so many computers in parallel (i.e. it could be so expensive), that it may become impractical: the benefits of calibrating \hat{F} could be outweighed by the time and cost (i.e. time and monetary expense) of its calibration. Hence, changes to a NN that decrease the number I will create a benefit.
3. Size of the training set—the number of instances used in the training set could also be a limiting factor. In some cases, that number may be limited by practical reasons (e.g. there are a limited number of instances of images for training). In some other cases, it may be possible to obtain more instances, but they may be difficult or expensive to obtain (e.g. a NN that tries to calibrate a function that gives optimal set up for a power plant, given different input conditions like price of the electricity in the power markets, load of the national power network, time of the day, day of the week, week of the year, price of the fuel of that runs the plant, or level of the water in a dam, personnel availability, present weather conditions, weather forecasts, etc.). As a result, variations of NNs that can decrease the number of instances in the training set needed to obtain the same (or better) result constitute an improvement to them.

It must be noted that a related matter to the issues just described is the dimensionality of the input space, n. In general, the greater n, the more difficult it is to train a NN. By this it is meant that as the size of the input space increases, the number of instances in the training set also needs to increase greatly, and this relationship tends not to be linear: if the size of the input space doubles, the number of instances required in the training set may more than double; this relationship most often explodes and can be exponential. Also, the greater the dimensionality of the input space, the greater the number of iterations in the learning loop may be needed, the deeper the NN may be needed to achieve useful results (deeper NN means more complex to compute its forward and backwards propagation).

Having said this, it must be noted that, in theory, one of the potential strengths of NNs is that they can cope with an input space of high dimensionality, should there be enough computing power available.

Another strength of NNs is that, in theory, there always exists a NN deep enough to mimic any function F, as long as F has certain minimal properties that are often met in real-live situations. However, this strength comes with the challenge of finding the correct NN architecture (i.e. hyper parameters) and the subsequent computational challenge of training a NN. That challenge can be so big that it may be impossible to train the NN in real-live situations.

Hyper Parameter Optimisation

The process of finding the optimal hyper parameters is typically a highly empirical process. By this it is meant a “manual” trial-and-error process in which the skilled individual in the art tries different values of the hyper parameters until the obtained \hat{F} is considered good enough.

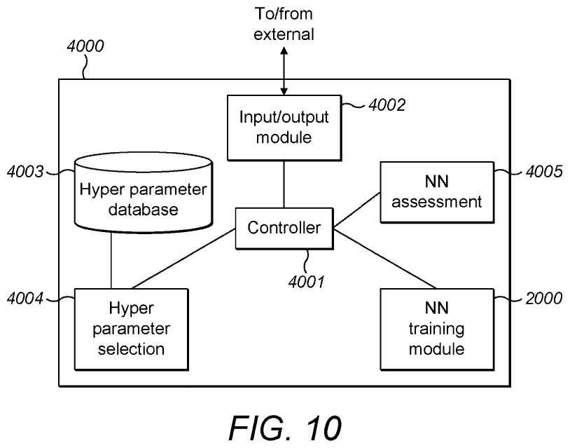

As a result, the NN training module 2000 lives inside a supra-module 4000 that performs the task of finding the optimal hyper parameters. This is illustrated in FIG. 10. This module 4000 is composed of a controller module 4001, an Input/Output module 4002, a hyper parameter database 4003 that contains all possible hyper parameter configurations, a hyper parameter selection module 4004, the previously-described NN training module 2000 and a NN assessment module 4005.

Once a problem to be solved (e.g. finding the function that gives the optimal set up of a power plant) is passed to the controller 4001 via the Input/Output module 4002, the parameter selection module 4004 chooses a hyper parameter combination from database 4003. Subsequently, the controller 4001 passes those hyper parameters to the NN training module 2000, that returns the optimal values for the parameters for the architecture defined by the given hyper parameters. Then, module 4005 performs an assessment of whether the NN calibrated by module 2000 is good enough for its application.

For example, if the NN is intended to recognise vehicle number plates in pictures, module 4005 runs the NN through a testing set of vehicle pictures (that is typically different from the training set used inside module 2000) and assesses the percentage of accuracy in the results. If it is above a certain threshold (e.g. 99%), then the NN is deemed to be good enough. If module 4005 gives a positive verdict, the obtained combination of hyper parameters and parameters are passed out from module 4000 via the Input/Output module 4002. If the verdict is negative, the controller 4001 moves again to the hyper parameter selection module 4004, that selects a different combination of hyper parameters from database 4003 from the once used in previous attempts, then module 2000 calibrates the parameters of the new combination of hyper parameters, module 4005 assess the quality of the NN, etc.

This process continues in a supra-hyper calibration loop until module 4005 provides a positive assessment.

As said, this iterative supra-loop is often a highly empirical process, in which the individual, with the appropriate skill in the art, starts with a set of hyper parameters that are typically very simple (e.g. one layer and one neuron) and starts increasing its complexity sequentially until the computation of module 4005 gives a positive result. This iterative supra-loop may need lots of interactions before module 4005 gives the positive result.

As a result, the more computationally efficient that the NN calibration module 2000 is, the more efficient the calibration of the hyper parameters carried out by module 4000 will be. Module 2000 can be become more efficient by improving on any or a combination of the three challenges explained above: precision, number of learning iterations and total number of instances in the training set.

Hence, an improvement of any of those is for the benefit also of the supra-hyper calibration computation.

Function Approximation and Interpolation Schemes

Given a function

y=F(x₁,x₂,x₃, . . . ,xₙ)

An alternative way to create a replica to it is via interpolation frameworks. In them, a function

y̅=F̅(x₁,x₂,x₃, . . . ,xₙ)

is created, with the intention that F(x₁, x₂, x₃, . . . , xₙ)≈F̅(x₁, x₂, x₃, . . . , xₙ) for the relevant input domain Ω; i.e. (x₁, x₂, x₃, . . . , xₙ)ÅΩ.

Simple Approximation and Interpolation Schemes

Some of the most simple approximation schemes are the simple interpolation frameworks. In them, the values of the function F are known in a number of input instances, “m” sets of values (x₁, x₂, x₃, . . . , xₙ). That is:

$$[ \begin{matrix}{x}_{1}^{( 1 )} \\ … \\ {x}_{n}^{( 1 )}\end{matrix} ] [ \begin{matrix}{x}_{1}^{( 2 )} \\ … \\ {x}_{n}^{( 2 )}\end{matrix} ] … [ \begin{matrix}{x}_{1}^{( m )} \\ … \\ {x}_{n}^{( m )}\end{matrix} ] , [ {y}^{( 1 )} , {y}^{( 2 )} , … , {y}^{( m )} ]$$

This is the so-called in the ad “interpolation points” or “anchor points”,

The function F̅ is defined so that, in each of the anchor points, it gives exactly the same value as F. That is,

F̅(x₁⁽ⁱ⁾,x₂⁽ⁱ⁾, . . . ,xₙ⁽ⁱ⁾)=F(x₁⁽ⁱ⁾,x₂⁽ⁱ⁾, . . . ,xₙ⁽ⁱ⁾)

If F̅ is required to give a value in intermediate points, that lie between the anchor points, an interpolating computation is performed. Some of the most common interpolating schemes are the linear or cubic spline interpolation frameworks.

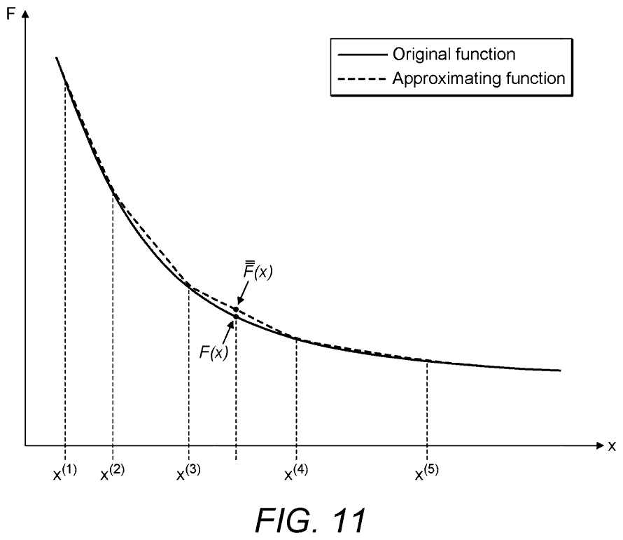

As an illustrative illustration, FIG. 11 shows a linear interpolation framework. The figure represents one dimension in the input domain (i.e. n=1) for ease of illustration, but it must be understood that many of the interpolation frameworks can be extended to high dimensions without loss of generality.

Complex Approximation and Interpolation Schemes

More complex approximation and interpolation schemes include polynomial interpolations and other frameworks based on Function Spectral Decomposition.

It must be noted that the following explanations on interpolation schemes are based on the one dimensional case (i.e. n=1) for ease of illustration; however, many of the interpolation schemes discussed have or can be extended to higher dimensions without loss of generality.

Polynomial Interpolation

It is known that, if there are m values of a function F(x), there is only one unique polynomial of degree at most m−1 that passes by those m values. Let this be termed polynomial pₘ(x), where

$${p}_{m} ( x ) = {\sum }_{j = 0}^{m - 1} {b}_{j} \cdot {x}^{j}$$

Given m anchor points, a potential calibration for the interpolator F̅(x) is that polynomial. That is:

F̅(x)=pₘ(x)

Where, at each of them anchor points {x⁽ⁱ⁾}ᵢ₌₁^{m}, the value of F̅(⋅) is the same as F(⋅). In other words,

$$\overline{\overline{F}} ( {x}^{( i )} ) = {\sum }_{j = 0}^{m - 1} {b}_{j} \cdot {x}^{{( i )}^{j}} = F ( {x}^{( i )} ) = {y}^{( i )}$$

Calibrating F̅(⋅) means finding out the values of the m coefficients {bᵢ}ᵢ₌₀^{m-1}. It is known that this can be easily done; for example, by solving a set of m linear equations.

Often, pₘ(x) converges to F(x) as m increases, in which case it is a good candidate for F̅(x) However, in some other cases it may diverge, in which case it is seen in the art as a bad candidate.

“Convergence” means that, as m increases, the maximum difference between any value of pₘ(x) in Ω and its corresponding F(x) goes to zero. “Divergence” means that it does not go to zero.

Functional Spectral Decomposition

It is known that under some conditions for the function F(x) (e.g, that it is analytical, continuous, Lipsitz continuous, square-integrable, etc. in a given interval (a, b)), F(x) can be expanded into an infinite series of functions. That is:

$$F ( x ) = {\sum }_{j = 0}^{∞} {c}_{j} \cdot {T}_{j} ( x )$$

where the collection {Tⱼ}ⱼ₌₀^{∞} is a base of orthogonal functions. That is, there exists a norm ξ(x) so that

$${\int }_{a}^{b} {T}_{i } ( x ) {T}_{j} ( x ) ξ ( x ) dx = 0 if i \neq j .$$

Examples of a base of orthogonal functions include sin^{j}(x), cos^{j}(x), Chebyshev polynomials, Legendre polynomials, etc.

Given a function F(x), and given a base of orthogonal functions, calibrating its infinite series means computing the collection of coefficient {cⱼ}ⱼ₌₀^{∞}. This can be done computing

$${c}_{j} = {\int }_{a}^{b} F ( x ) {T}_{j} ( x ) ξ ( x ) dx$$

In many cases, this calculation is a difficult task fora computer. Often, it is difficult because of the large number of operations needed by the computer in its computation. The reason for this is that typical computational methods used in the art to compute an integral in an interval (a, b) with a relevant degree of accuracy requires the evaluation of the integrand (F(x) Tⱼ(x) ξ(x)) in many points inside that interval. This can be costly to compute, mainly because, often, the function F(x) is difficult to evaluate by a computer.

It is known that, for many of these basis, the truncated expansion

$${F}_{N} ( x ) = {\sum }_{j = 0}^{N} {c}_{j} \cdot {T}_{j} ( x )$$

Converges to F(x) as →∞. That is,

F_{N}(x)≈F(x)

as N→∞. When so, the truncated expansion can be a good candidate for F̅(x) and it is for this reason that this truncated expression is used by computers to mitigate this problem

Spectral Decomposition and Polynomial Interpolation

Many of the outlined approximation frameworks via interpolation or spectral decomposition provide good candidates to substitute F(x) in a computation. However, the present inventor has appreciated that some of them have some special properties that make them particularly good.

Chebyshev Polynomials

When the basis of orthogonal functions are Chebyshev polynomials, and when F(x) is analytical (i.e. smooth enough), it has been demonstrated that its truncated series converges to F(x) exponentially. This is an extraordinary property that can be very useful when finding a candidate for F̅(x), because this means that with a very low N, relative to other approximation frameworks, it is possible to find an approximation F_{N}(x) that is going to be both very accurate and is very easy to calibrate (i.e, requires very few cⱼ to compute).

Furthermore, if the values of the function F(x) are known at the extrema of the Chebyshev polynomial of degree N, and/or the zeros of the polynomials, then the coefficients aⱼ can also be computed very easily using a Fast Fourier Transform.

Furthermore, if the values of the function F(x) at the so-called “Chebyshev points” (or “Chebyshev nodes”) of degree N+1 are used as anchor points in a polynomial interpolation scheme of degree at most N, then the polynomial interpolant p_{N} converges to F(x) and F_{N} (X) exponentially as N→∞. Polynomial interpolants are very easy to calibrate, it can be done by solving a set of N linear equations. Hence, this property is very useful when trying to find a candidate for a substitute of F(x) in a computation, as this p_{N} is going to be both exponentially convergent and easy to calibrate.

This is important, so further clarifying it: polynomial interpolants in generic points have standard convergence properties, but in some cases they can have bad properties as they can diverge. However, the selection of certain anchor points for interpolation in a polynomial scheme produces the remarkable effect that, as long as the function has some basic smoothness properties, the polynomial interpolant converges exponentially to the function (i.e. ultra-fast). As a result, the present inventor has realised that this scheme is ideal for interpolation functions in real world problems, as they are often smooth functions.

Furthermore, it has been shown that such polynomial p_{N} can be evaluated most efficiently and stably in a computer using its barycentric interpolation formula:

$${p}_{N} = \frac{{\sum }_{j = 0}^{N ′} \frac{{( - 1 )}^{j}}{x - {x}^{( j )}} {F}^{( j )}}{{\sum }_{j = 0}^{N ′} \frac{{( - 1 )}^{j}}{x - {x}^{( j )}}}$$

where F^{(j)} is the value of the function at the Chebyshev points, and x^{(j)} are the Chebyshev points, of degree N. In other words, there is no need to even compute the coefficients cⱼ for evaluation in a computer; this makes this framework further especially powerful for computer calculations.

Chebyshev Points, Entropy and Information Theory

On one hand, the reason why Chebyshev points are so good to approximate a function can be related understood via potential theory and minimisation of a system of energy in the complex plane. The function at stake, F, is extended into the complex plane and a potential is defined. When building a polynomial interpolant with a number of generic N anchor points, the error of the approximation is driven by a term that can be seen as the energy of N charges (the anchor points) in the potential. That energy (i.e. the error) is minimised when the geometry of the charges corresponds to the Chebyshev points.

On the other hand, the concept of entropy and information theory is well known in the art. In information theory, entropy is a measurement of the density of information. Regions with a lot of information correspond to low entropy, where the lower the entropy, the higher the density of information.

Applying this concept to the problem of function approximation and interpolation, the Chebyshev points can be seen as points of low entropy, as with the value of the function in those points, a polynomial can create a super-accurate version of the function. In other words, when the value of the function in Chebyshev points is used, a special effect is created via the minimisation of energy described above, and as a result the information of the function in those points provides a great deal of information about the function. As a result, an extraordinarily accurate version of the function can be created.

Hence, Chebyshev points can be seen as points of low entropy.

Other Special Basis

Other orthogonal basis show similar special convergence properties when interpolation on the special points they can define. They include, for example, sine and cosine functions, Legendre polynomials, Gegenbauer polynomials and Jacobi polynomials. Further orthogonal basis function that can be used include Bessel functions, Hermite polynomials, Laguerre polynomials, Chebyshev polynomials, Spherical harmonics, Walsh functions, Zernike polynomials, Wilson polynomials, Meixner-Pollaczek polynomials, continuous Hahn polynomials, continuous dual Hahn polynomials, a classical polynomials described by the Askey scheme, Askey-Wilson polynomials, Racah polynomials, dual Hahn polynomials, Meixner polynomials, piecewise constant interpolants, linear interpolants, polynomial interpolants, gaussian process based interpolants, spline interpolants, barycentric interpolants, Krawtchouk polynomials, Charlier polynomials, sieved ultraspherical polynomials, sieved Jacobi polynomials, sieved Pollaczek polynomials, Rational interpolants, Trigonometric interpolants, Hermite interpolants, Cubic interpolants, and Rogers-Szegö polynomials.

The fundamental idea of those orthogonal bases with special convergence properties is that, under their approximation framework, the function being approximated can be extended to the complex plane, where a potential can be defined, and an energy function can then be further defined, given by the geometry (i.e. distribution) of the anchor points. This can be understood by seeing each anchor point as a charge living in the defined potential. In other words, given a geometry of anchor points, they can be seen as creating an energy in the potential previously defined, as if they were charges.

This is related to the problem of approximation theory because, under certain conditions, the error of the approximation defined by the expansion on the orthogonal basis is driven by the energy of the system. Hence, the geometric of the anchor points that minimise that energy is the geometry that minimises the error of the approximation. In other words, given the orthogonal basis, minimising the error of the approximation is equivalent to minimising the energy of the charges defined by the anchor points; a problem well studied in the field of Physics.

In this way, other special basis and special distribution of anchor points can be found and used in real-live problems optimally.

Challenges of Spectral Decomposition and Interpolation Frameworks

The described computational framework offers very well suited ways to compute an approximation to a given function that then can be used in a computer calculation in a way that, often, is more efficient to evaluate than the original function, without relevant loss of accuracy.

In order to calibrate the interpolator, the calculation needs to know the value of the function at stake at a relatively small number of points, the “anchor points”. With this information (i.e. the anchor points and the value of the function in those points) the approximation is calibrated, and it can be subsequently used instead of the original function F.

This is a good numerical procedure as long as (i) the accuracy of the approximation function F̅ is high enough for the purpose of the calculation and (ii) the number of times the original function F needs to be computed for the calibration of the approximating function is lower than the number of times it had to be computed, if the approximation route was not taken in the calculation.

This creates a balancing game that needs to be optimised. Generally, the more anchor points the approximation framework has, the more accurate the approximating function will be. For many applications, simple interpolation frameworks (e.g. linear interpolation in equidistant points) is good enough, but in some other applications more sophisticated frameworks are needed to ensure high degree of convergence with few anchor points.

In particular, the spectral decomposition via basis of orthogonal functions can be very useful here, as they can optimise that balance. In particular, it has been seen that using some special points, defined by certain basis of orthogonal functions, as anchor points, can be of great benefit as they can minimise the error of the approximation; for example, Chebyshev or Legendre polynomials. Even further, the case of Chebyshev polynomials are particularly useful as it is known that the error of the explained approximation framework based in them goes to zero exponentially for many real live functions.

A second challenge comes around the problem of dimensionality of the input space. The explained approximation frameworks operate with a few anchor points, in which the value of the function is known with maximum precision, and then the framework provides a way to provide values in between those points. So far, a one-dimensional case has been presented, in which the function to approximate has one variable as input. The approximation frameworks can generally be extended to higher dimensions, but that tends to come at the cost of increasing the number of anchor points; hence the number of times that the original function needs to be computed. The reason is that, to fill the space with anchor points, the number of anchor points grows exponentially with the number of dimensions. For example, if a function needs, say, 5 points for one dimension, it tends to need 25 for two dimensions, 125 for three dimensions, 625 for four dimensions, etc.

As a result, if the dimensionality is too high, the outcome may be a situation that it is impractical to create an approximation function via one of the interpolation frameworks. There are several techniques that may be used in such situations, as described in greater detail below.

Benefits

Finally, despite these challenges, an important key strength of interpolation frameworks is that they can capture non-linear relationships very well, both within a dimension and between different dimensions in the input space.

This is a key property exploited by the present invention (described later).

Higher-Dimensional Input Spaces

Let's say that we have a function in n-dimensions

F(x): [a₁,b₁]×[a₂,b₂]× . . . ×[aₙ,bₙ]→

[symbol]

that maps points in [symbol] ⁿ into [symbol] , and where the value of such a function in a number of m in anchor points (in [symbol] ⁿ) are known. We can use this information to construct an approximating function

F̅(x):[a₁,b₁]×[a₂,b₂]× . . . ×[aₙ,bₙ]→

[symbol]

so that F̅(x)≈F(x).

A “tensor” has two components: firstly, a collection of anchor points in an input domain (x) (the “mesh” or “grid”): secondly, values of a function (F(x)) on those anchor points. The input domain can have any dimensionality. For dimensions greater than one, we can define the anchor points in each dimension, and then compute the multi-dimensional grid by multiplying the anchor points in each dimension. In each dimension, the anchor points can in principle follow any configuration (e.g. equidistant, Chebyshev nodes, etc.).

As an illustrative example, a 1-d tensor with m points is formed by

x⁽¹⁾,x⁽²⁾, . . . ,x^{(m)};F(x⁽¹⁾),F(x⁽²⁾), . . . ,F(x^{(m)})

A 2-d tensor with m points is formed by

$$[ \begin{matrix}{x}_{1}^{( 1 )} \\ {x}_{2}^{( 1 )}\end{matrix} ] , [ \begin{matrix}{x}_{1}^{( 2 )} \\ {x}_{2}^{( 2 )}\end{matrix} ] , … , [ \begin{matrix}{x}_{1}^{( m )} \\ {x}_{2}^{( m )}\end{matrix} ] ; F ( [ \begin{matrix}{x}_{1}^{( 1 )} \\ {x}_{2}^{( 1 )}\end{matrix} ] ) , F ( [ \begin{matrix}{x}_{1}^{( 2 )} \\ {x}_{2}^{( 2 )}\end{matrix} ] ) , … , F ( [ \begin{matrix}{x}_{1}^{( m )} \\ {x}_{2}^{( m )}\end{matrix} ] )$$

This idea can be extended to any dimensionality n.

For a function of dimension n, a tensor can be created with mᵢ anchor values for the first dimension, m₂ anchor values for the second dimension, etc., so that the number of anchor points m is given by

m=m₁·m₂· . . . ·mₙ

This shows that given a number of anchor values per dimensions, the number of anchor points grows exponentially with the number of dimensions n. For example, if mᵢ=10 for each dimension, the table below shows the number of anchor points in the tensor:

| Dimensions (n) | Num. anchor points (m) |
|---|---|
| 1 | 10 |
| 2 | 100 |
| 3 | 1,000 |
| . . . | . . . |
| n | 10ⁿ |

As a result of the exponential growth of the number of points in the tensor, the dimensionality of a function F to be approximated plays an important practical role in the computation of approximation frameworks. This is because, as n grows, the size of the tensor becomes exponentially larger and larger, which can makes it (i) increasingly difficult to store and operate within a computer system and (ii) we need to compute the value of the function F in an exponentially increasingly high number of points, which can also be a problem if F is slow to compute.

A number n, or collections of mᵢ's, at which the dimensionality becomes a problem cannot generally be determined as it depends fully on the problem at hand (i.e. the speed of the computation of F(x), the precision needed in the overall computation, etc.) and the computer system being used.

There are several techniques to manage this problem depending on the conditions at hand. The next section shows three examples as illustration for what approximation/interpolation frameworks can be built for various values of n.

Sliding Techniques

One solution used in the art that increases the number of dimensions that an interpolation or spectral decomposition technique can deal with, is the so-called ‘sliding technique’.

As an example let there be a function of, for example, 20 dimensions, for which an interpolator is to be built. Assuming that 5 anchor points are required in each dimension, the total number of anchor points in the interpolation is 5²⁰, or around 95 trillion. This is unpractical in many real-live calculations even using the most powerful super computers.

In some functions, many of the so-called “cross terms” hardly contribute to the valuation of the function. That is often the case, for example, in pricing approximation functions used in finance for market risk calculations. By “cross terms” it is meant the terms of the function (where a term is a part of the function that sums the rest) that contains multiplications of different variables. For example, in ƒ(x, y, z)=4x²+5y²+6z²+2x+3y+4z+0.01xy+0.3yz+0.002zx, the “cross terms” are the last three terms shown.

When that is the case, the pricing interpolator can be done in “slides”, one that deals with each variable. For example, the function just seen could be approximated with an interpolator or a Spectral Decomposition technique by

ƒ(x,y,z)≈ƒ̅₁(x)+ƒ̅₂(y)+ƒ̅₃(z)

where each ƒ̅ᵢ(⋅) is a 1-dimensional interpolator for each variable, disregarding the cross terms.

With this technique, the number of anchor points can be greatly reduced. Using the example of 20 dimensions mentioned above, it would need 5×20=100 points, A massive reduction compared to the 95 trillion.

Also, mixes of multidimensional slides can be done. If, for example, it is known that the cross-terms between, say, the first and second dimension, and between the third and fourth dimension are important, it is possible to carry out two 2-dimenisonal interpolations for first and second, and the third and fourth, and then 1-dimensional interpolations for all other dimensions. This would lead to, in our example, 5²+5²+5×18=140 anchor points. Again, this is much better than the 95 trillion.

In general, depending on the relative size of the cross terms relative to all other terms, this technique can be extended without loss of generality so that an approximating interpolator can be built as sum of slides, each slide covering a limited number of dimensions.

Completion Techniques

Another technique that can increase the number of dimensions that an interpolation or spectral decomposition technique can deal with is a so-called ‘completion’ technique. Using the example described above, with 95 trillion anchor points, i.e. n=20, as mentioned above building an interpolation framework with that many anchor points is very challenging. The challenge comes from either computing the value of the function on such a large number of points, storing them in a computer system, using them, or any combination of these.

The completion techniques consist in using only the information of a subset of the original totality of anchor points (e.g. using 1% of the 95 trillion points), and completing the information from those points to the totality of the anchor points, so that, when performing an evaluation of the interpolating function, an approximation to that interpolating function is used. In many cases, that approximation is very accurate and easy to evaluate, to the extent that it serves the purpose of the original interpolating function, and can be used instead.

In more detail, let us say that we have a tensor A that we want to use to approximate a function F, in all twenty dimensions in this example. Tensor A is very large to store, and it is computationally costly to evaluate F in all the anchor points.

In this technique, one evaluates only a fraction of the grid of points that defines the tensor. A typical fraction is of about 5%, and is chosen randomly. This gives a grid of points along with real values on only 5% of the grid points. Building such a tensor, which we call a partial tensor, is typically computationally viable.

The completion technique relies on exploring a particular type of tensors. The type of tensors we are interested in are expressed in tensor train (TT) format and have low rank. The key property of these tensors is that they can be encoded (i.e. stored in a computer system) with little information. In particular, the value on each of the grid points is not needed. This is particularly useful for tensors of high dimensions since the values associated to all grid points can be encoded with a much smaller amount of information. For example, 20-d tensors in TT format and of low rank can easily be stored in a computer and operated with.

The completion technique basically explores the space of tensors in TT format of low rank, finding one that restricted to the 5% of points for which we have values on tensor A is as close as possible to A. Denote the tensor found by the completion technique by X.

If the tensor A to be approximated by X is regular enough, 5% of the points will be sufficient for tensor X to approximate tensor A, not only on the 5% of the points available for A, but on all of A. Given that Xis a tensor that can be operated with (due to the fact it is expressed in TT format and has low rank), X is used instead of A in every calculation needed.

The user can use the chosen multi-variate interpolation technique on X as a substitute of A to build the approximating function F̅.

Further details of these completion techniques can be found in publicly available documents. One example can be found in the document by K. Glau, D. Kressner and F. Statti, ‘Low-rank tensor approximation for Chebyshev approximation in parametric option pricing’, February 2019, available in arxiv.org, where compressions of the order of 3×10¹⁷ are reported. Another example can be found in M. Steinlechner, Riemannian optimization for high-dimensional tensor completion, SIAM J. Sci. Comput., 38 (2016), pp. S461S484, http://dx.doi.org/10.1137/15M1010506

Principal Components Analysis Technique

Another technique to manage the dimensionality of the input space of an interpolation framework is Principal Components Analysis which takes advantage of the underlying structures of the relevant data in the input space.

Let's say that the input to a interpolation framework has n dimension. When the data that serves as input of the interpolation shows some degree of correlation, an n×n correlation matrix can be build with the date. It can be then diagonalized, and the eigen-values of the diagonalised matrix can be sorted in descending order. The higher the eigen-value, the more relevant its corresponding eigenvector is in the input data. In many cases, we can take the m first eigenvalues (m<n) with their eigenvectors, that take for example 99.9% of the information in the original data, and do the interpolation in that m-dimensional space with minimal loss of information (e.g. 0.1%), In more detail, for example, the points x in the input space where we are interested to know the value of the function F(x) via its approximation function F̅(x) could be a subset of the whole input space, e.g. this subset may be found by spectral analysis of the points in the input space, also referred to as principal components analysis or eigenvalues analysis.

This is often seen as a good technique when the points x in the input space where we are interested to know the value of the function F have a high degree of dependency. When so, we could construct the n×n correlation matrix and diagonalize it. From the diagonalization one obtains n eigenvalues (λ₁, λ₂, . . . , λₙ). Each eigenvalue corresponds to one eigenvector in the input domain. The eigenvectors give a new coordinate reference and define a change of coordinates in the input domain. The eigenvalues can be sorted, from high to low values. The eigenvalues with high values correspond to subdomains in the input space that are very relevant, while those with low values correspond to less relevant, or irrelevant, points in the input space.

For instance, if n=1000, and the 20 first eigenvalues describe 99.99% of the relevant points in the input domain then we could restrict ourselves to the subdomain generated by the corresponding 20 eigenvectors. By generating an approximating function F in the space of those eigenvectors (e.g. a 20-dimensional function) we can build an approximating function to F in the whole input domain.

When we need to evaluate the function F in a generic point x (of 1000 dimensions), first we compute its expression in the coordinates of the eigenvectors. Then, we restrict it to the first 20 coordinates and compute the value of F in those 20 coordinates for that point. This is the approximation to F(x) that we are looking for.

In other words, we have reduced an approximation problem in 1000 dimensions to an approximation problem in 20 dimensions. Then, we can use any of the techniques that work for n=20, for instance the sliding and/or completion techniques described above. The principal components analysis may be used to reduce an approximated problem in any suitable number of dimensions, for instance for an approximated problem in at least 100 dimensions.

The principal components analysis technique is applied in many technical fields, ranging from neuroscience to quantitative finance. More information can be found in https://en.wikipedia.org/wiki/Principal_component_analysis.

The examples above are illustrations for a number of values of n. However, it must be understood that those techniques may be applied for any generic n, that a combination of them could be used, and that there are other techniques that could be used as well.

Computational Effort

The computational effort of interpolation frameworks is two folded. Firstly, in a “building” phase, the framework needs to know the value of the approximated function in a number of anchor points and build the approximating function; the interpolator. The effort to compute the approximated function is often high and tends to take but vast majority of this computation. Secondly, in an “evaluation” phase, often several values of the approximating function via the interpolator must also be computed. Often, this evaluation is pretty fast in a computer as it tends to be based in linear or simple polynomial calculations.

Often, the bulk of the computational effort comes from the building phase. More particularly, from the time that the original function (the approximated function) needs to be evaluated in order to provide the values of the function at the anchor points.

Assuming there is an interpolation framework, in d dimensions and in each dimension the framework uses n₁, n₂, . . . , n_{d} number of anchor points. The total number of anchor points is, then, n₁*n₂* . . . *n_{d} However, if a sliding technique is used as described above, with 1-dimensional interpolator in each slide, then the number of anchor points is n₁+n₂+ . . . +n_{d}.

For simplicity, assuming that the interpolation uses the same number of anchor points per dimension (i.e. n₁=n₂= . . . =n_{d}), and as an illustrative example let it be assumed that that number n=10 and that d=6. In this case, the total number of anchor points is in the first case is 10⁶=1,000,000. If the interpolation framework uses six 1-dimensional slides, then the total number of anchor points is 6*10=60, much lower than the previous 1,000,000.

This rule can be generalised. If the interpolation framework uses one 2-dimensional slide, and four 1-dimensional ones, the number of anchor points is 10²+(6−2)*10=140. If it use two 2-dimensional slide, and two 1-dimensional ones, then the number of anchor points is 2*10²+(6−4)*10=220.

A recursive rule can be built. If the interpolation framework uses “s” number of slides, each with n anchor points, and each with a dimensionality of d₁, d₂, . . . , dₛ, then the total number of anchor points is

$${\sum }_{i = 1}^{s} {n}^{{d}_{i}}$$

Furthermore, if each dimension has a different number of anchor points, then the total number of anchor points would be

$${\sum }_{i = 1}^{s} ( {\prod }_{j = 1}^{{d}_{i}} {n}_{j} )$$

Note that the sum of all dimensions must be equal to the total dimension of the interpolation framework.

That is,

$$d = {\sum }_{i = 1}^{s} {d}_{i}$$

This formula shows the balance between the accuracy of the interpolation framework and its computational cost. The less slides (the lower s), the higher the accuracy, but also the higher of anchor points, hence more computationally demanding.

Finding the right balance between these two hyper parameters in the interpolation framework depends on the problem at stake, and it is a highly empirical and slow process, that is often strongly driven by the experience and skill of the individual skilled in the art.

Overview of the Present Invention

The above discussion has been concerning NNs and other approximation frameworks based in interpolation and Spectral Decomposition. From now on, these other approximation frameworks will be referred to as “interpolation frameworks” unless otherwise stated.

On one hand, it has been shown above that NNs can deal with high-dimensional input spaces, but at the cost of computational demand in the training step. Also, there is a trade-off between accuracy and NN depth and computational need in the training step. In theory, a vast number of real-live functions can be approximated with high accuracy if a NN is built with enough depth; however, the deeper the NN, the more computationally demanding it is to train.

On the other hand, interpolation frameworks can be easy and effective to implement and run in a computer. Also, they can deal very well with the accuracy challenge; if a simple interpolation framework (e.g. liner interpolation in equidistant points) does not give enough accuracy, it is possible to use more sophisticated ones that ensure extreme accuracy without any significant increase in computational demand (e.g. polynomial interpolation or spectral decomposition in Chebyshev points can ensure machine precision with a relatively small number of points (e.g. 50) in many real-live problems).

Also, interpolations frameworks are very good and capturing non-linear relationships, both in a given dimension and between different dimensions in the input space. However, they come at the expense that they tend to only work in practice for a relatively low number of dimensions of the input space, as if the input space has too many dimensions, the number of anchor points needed to calibrate the interpolator may be too high.

The present invention puts the strength of interpolation frameworks into NNs so that the final outcome is a better NN, especially with respect to the computational cost of the learning step. This new AI structure is hereinafter referred to as a Hybrid Neural Network (hNN).

### DESCRIPTION OF EMBODIMENTS OF THE PRESENT INVENTION

Typical successful architectures of NNs start with very high dimension in the initial layers (i.e. n^{[1]} is high), the same or higher than the dimension of the input space. Through subsequent layers, the dimensions are gradually decreased, until it gets to the last few layers with only a few neurons per layer, and then a single neuron in the last layer.

There is a logical reason for use of these types of architectures. For example, when processing images to, say, recognise faces in pictures, the first few layers tend to be dedicated to recognising edges of face parts, hence each neuron may be looking at small areas of the image. Then, subsequent layers put those small areas together into face parts like an eye, a nose, etc., hence looking at larger areas of the image. Finally, a final set of layers put those parts together to look at a face as a whole, hence looking at the whole image as one object.

Something similar takes place in the field of speech recognition. The first few layers tend to take care of recognising basic sounds, a second set of layers put them together into letters, a third set of layers deal with words and a final set of layers creates sentences.

Another example of this NN phenomenon can be observed in function approximation, such as the function that gives the price of a portfolio of financial instruments. The input space can be very large (thousands of market prices and variables like interest rates, etc.), but it is well known that the risk, and hence the price, of financial instruments tends to be highly driven by a handful of variables. A NN applied to this problem will typically reduce the dimensionality of the input space down to those few relevant variables. Then, by continuing to decrease the dimensionality of the problem, the NN learns the relationship between those few variables.

Parametrizable Functions

The functions described above are termed “parametrizable functions”. These functions may depend on many input variables, but the function can be equally expressed in terms of a reduced number of variables.

Turning now to an illustrative example, for ease of explanation, this function is very simple, only two dimensions in the input space, but the idea can be easily extended to other more sophisticated (multidimensional) cases.

Taking the function

y=F(x₁,x₂)=x₁⁴+x₂⁴+2x₁²x₂²+1

That function is actually:

y=d⁴+d²+1

where d is the distance between the point (x₁, x₂) and the centre of coordinates. That is, even though the function F(x₁, x₂) has two dimensions in the input space, it can be perfectly expressed in term of one single variable (hence one dimension), d.

That is, the function F(x₁, x₂), that depends on two parameters x₁, x₂, can be re-parametrised into one parameter, d. (note that the word “parameter” in the context is different to the one used before in the context of NNs)

It must be noted that, sometimes, the parametrisation is not exact, but approximated. For example, the parametrisation gets to the same value of the function with a, say, 1% error. So when an approximation of the function is sought to be built, the parametrisation will be good as long as it is appreciated that it is with an approximation of that same error.

Going back to the example F(x₁, x₂), this can be expressed as a composition of two functions: F₁(x₁, x₂) that takes the (x₁, x₂) pair into d, and F₂ (d) that computes y from d.

d=F₁(x₁,x₂)=\sqrt{x₁²+x₂²}

y=F²(d)=d⁴+d²+1

y=F(x₁,x₂)=(F₂·F₁)(x₁,x₂)

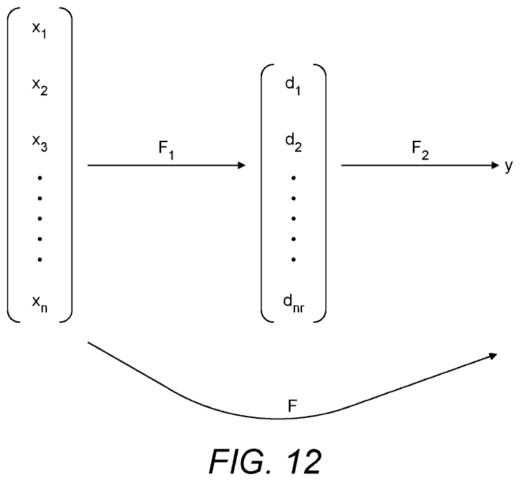

This is illustrated in FIG. 12 for a generic dimensionalities, where the input space (i) has n dimensions and the reduced space (\vec{d}) has n_{R} dimensions, where n_{R}<n.

Hybrid Neural Networks

In past sections, it has been shown that using a function F, it is possible to build a replica of it via NNs (\hat{F}) or via interpolation (F̅). In an embodiment of the present invention an hNN can be built. In such an embodiment it is possible to decompose the NN version of the function, \hat{F}, first into a function \hat{F}₁ that is going to be calibrated via prior art NNs so that the dimensionality of the input space is reduced. Then, a second function F̅₂ is created via interpolation, so that the final NN function \hat{F} is the composition of \hat{F}1 and F̅₂.

\hat{F}=F̅₂·\hat{F}₁

The idea is that, in this way, the hNN takes advantage of the strengths of both the traditional NNs and the interpolation approximations where each is strongest.

As said, \hat{F}1 reduces the dimensionality of the input space. It must be noted that, if the whole NN is a traditional (prior art) one, then the NN function will generally be \hat{F}=\hat{F}2·\vec{F}₁, where \hat{F}₁ is going to reduce the dimensionality of the input space exactly the same as in the case of the hNN, and \hat{F}2 takes care of the function F₂ as a typical NN in the art. Hence, a hNN will offer a benefit over a typical NN when F̅₂ is more efficient than \hat{F}₂. This increase in efficiency takes place in the learning step.
1. Precision—as said, interpolation frameworks can be very good at capturing non linearities, specially the advanced ones like those based in Chebyshev polynomials. This is in contrast to NNs, that often need many layers (i.e. a lot of depth) to capture those non-linearities. By increasing the number of interpolating points, the approximating function F̅₂ can be guaranteed to converge to F₂ for many practical real-live shapes of F₂. In the case of the advanced procedures like Chebyshev, this convergence is exponentially fast; i.e. with the value of F₂ in very few points (e.g. 50), F̅₂ can many times have machine precision (10⁻¹⁵).
Also, in their multidimensional version, they are very good at capturing nonlinear dependencies between different variables. This is in contrast to conventional NNs, where there may be many layers.
2. Number of learning iterations—in the described hNN, F₂ is taken care by one single interpolating layer, F̅₂. In the case of standard (prior art) NNs, F₂ will be taken care often by several layers of NNs so that the non-linearities and inter-variable dependencies are properly captured. As a result, the computation of \hat{F} in the forward propagation step, and of its counterpart background propagation step, will be more efficient for a hNN than a prior art NN.
3. Total number of instances in the training set—in the described hNN, the interpolating layer F̅₂ needs only the value of it in a reduced number of points, the anchor points. This can translate, hence, into a reduced number of instances in the training set, as compared to its equivalent in the prior art.
This is going to be particularly the case for the advanced interpolation methods. It has been shown that, in them, the anchor points can be seen as points of very high information, hence low entropy. In a prior art NN, the input space needs to be explored randomly so that it is as uniformly covered as possible. However, a hNN can take advantage that a few points of low entropy in the input space of F₂ carry a lot of information. Those points can be translated into points, or areas, of the input space of F, so that the collection of value of F for the generation of the instances in the training set can concentrate in those areas.

Another possible extra benefit of an hNN is that the calculation of the output of the NN when needed in real-live situations (i.e. the computation of the forward propagation), once the training has been done and finished, is typically faster via hNN than NN.

Expanding on this idea, an interpolation framework takes care of non-linearities in the function it is approximating; this has been already explained. This non-linearity is typically dealt with by NNs by a number of layers and neurons; often, lots of them are needed to match the non-linear approximation quality of an interpolation framework, specially of the good interpolation frameworks (e.g. Chebyshev). Evaluating an interpolation framework is usually very fast (i.e. efficient in a computer), as the whole operation is reduced to the evaluation of linear function and/or polynomials. However, evaluation of NNs, especially when they have lots of layers and neurons, require multiple evaluations of linear (e.g. compute the z of each neuron) and non-linear functions (e.g. activation functions in each neuron). As a result, the evaluation of an interpolating function in a computer can be more efficient than the evaluation of its NN counterpart.

Learning of Hybrid Neural Networks

In this section a description of how an embodiment of the present invention would be trained is presented.

Similarly to the previous description of NNs, two cases are considered: a static training set and a dynamic training set. In the static case, the instances of the training set are given at the beginning and do not change throughout the learning calculation. In the dynamic case, the training set can change in each iteration of the learning calculation.

The hNN comprises a number “L₁” of prior art NN layers, each layer with a number of neurons n^{[i]}, i=1 to L₁”. There is no restriction to the number of layers and number of neurons in each of them. Further to it, there is an interpolating layer. The output of this last layer is the output of the hNN, ŷ.

As illustration, a case of two dimensions is used in the input space for simplicity of the figures; however, it must be understood that the explanation can be extended to higher dimensions without loss of generality. In the illustrative example, hence, the dimensionality reduction will be from 2 dimensions to 1 dimension.

Static Traininq Set

In this illustrative example there are in instances in the training set. That is:

$$[ \begin{matrix}{x}_{1}^{( 1 )} \\ … \\ {x}_{n}^{( 1 )}\end{matrix} ] [ \begin{matrix}{x}_{1}^{( 2 )} \\ … \\ {x}_{n}^{( 2 )}\end{matrix} ] … [ \begin{matrix}{x}_{1}^{( m )} \\ … \\ {x}_{n}^{( m )}\end{matrix} ] , [ {y}^{( 1 )} , {y}^{( 2 )} , … , {y}^{( m )} ]$$

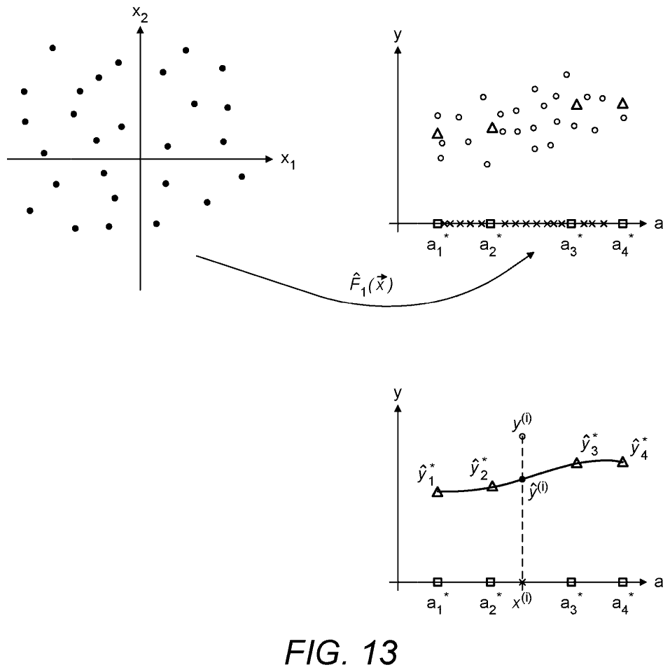

The input values for each instance (\vec{x}⁽ⁱ⁾) are shown in FIG. 13, left pane. Each dot is one of the rn instances. The parameters of the standard NN, \hat{F}₁, are initialised in the same manner as is usually done for prior art NNs. For each \vec{x}⁽ⁱ⁾, the output of \hat{F}₁, a⁽ⁱ⁾=\hat{F}₁(\vec{x}⁽ⁱ⁾) is computed; these are represented as little crosses “x” in the top right pane of FIG. 13. In the top right pane of FIG. 13, a⁽ⁱ⁾ is illustrated in the horizontal axis, and the respective y⁽ⁱ⁾ are illustrated as circles in the top right pane.

As a reminder, the goal of the learning calculation is, given a set of hyper parameters (in an hNN, the type of interpolation scheme becomes a hyper parameter), find the parameters of the hNN that minimise the Cost function. In this case, the hNN is composed of two parts:

\hat{F}=F̅₂·\hat{F}₁

In this example w is used to name the parameters of \hat{F}₁, the prior art NN part, and c is used to name the parameters of F̅₂, the interpolation.

One of the hyper parameters of the interpolation F̅₂ is the anchor points; they can be a set number nₗ of the chosen interpolation scheme, i.e. equidistant points, Chebyshev points, etc. Those points are illustrated with squares in FIG. 13, top right pane; the illustration shows nₗ=4. These are named a*ᵢ.

A candidate for F̅₂(a) now needs to be built via the interpolation scheme. For that, the values of F̅₂ at each anchor point a*ᵢ are required. There are several ways this can be done. For example, the y values of all the a⁽ⁱ⁾ in the vicinity of each anchor point can be taken, and then their average, or their average disregarding some outliers, or some other statistical metric can also be determined. Also, “vicinity” can be defined in a number of ways; for example, bands can be created between the anchor points that define which point a⁽ⁱ⁾ is linked to which anchor point, alternatively each a⁽ⁱ⁾ can be linked to its closest anchor point, etc.

In this way, the values of F̅₂ can be defined at the anchor points. These are referred to as ŷ*ᵢ. They are shown with a triangle symbol in FIG. 13, top right pane.

Given the interpolation scheme under consideration, and stablished as a hyper parameter of the hNN, it is possible to compute the function F̅₂ (a) from the collection of a*ᵢ and ŷ*ᵢ. That F̅₂ (a) is represented by a line in FIG. 13, bottom right pane.

For a given training set instance \vec{x}⁽ⁱ⁾, that has a corresponding a⁽ⁱ⁾, it is possible to compute ŷ⁽ⁱ⁾, which is the candidate of the hNN for the output of \vec{x}⁽ⁱ⁾. This is illustrated in FIG. 13, bottom right pane.

The goal of the hNN is to minimise a Cost function. So, a loss function for each instance “i” is defined (e.g. [symbol] (ŷ⁽ⁱ⁾y⁽ⁱ⁾)=1/2(ŷ⁽ⁱ⁾−y⁽ⁱ⁾)²), and then a Cost function is defined as explained previously in the prior art NN section. Then, a function minimisation calculation like gradient descent is applied, so that in each iteration of the learning loop, the hNN parameters, namely the w parameters and c parameters are updated, until the Cost function is minimised.

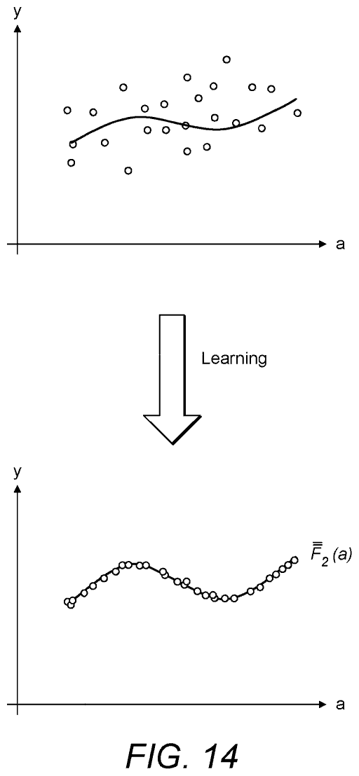

FIG. 14 shows an illustration of the effect that the learning process has. The state in the first iteration is illustrated in the top panel. To start with, in the first iteration, the circles form a wide “cloud”, because the parameters win \hat{F}₁ are randomly selected, so in general they will not perform the dimensionality reduction (a.k.a., factorization) needed; that is, they will not perform the correct parametrisation for the function \hat{F}. As the values of the parameter w are updated through subsequent iterations of the learning loop, the originally wide cloud of circles become narrower and narrower (along the vertical line) because the w parameters are updated iteratively so that the Cost function is minimised, which means that the function F̅₂ becomes better and better defined, and by this it is meant that the cloud of circles (FIG. 14 top pane) converge to become a line (FIG. 14 bottom pane).

When the Cost function has reached its minimum, the vertical width of the cloud reaches its minimum too, and the learning process has finished. In the limit, if the function F is perfectly parametrizable, and \hat{F}₁ is able to find such parametrization, then the cloud of circles should converge to form a clear line.

Dynamic Training Set

In the case of static training set, the in instances in the training set are given from the outset of the learning computation, and they never change. In some applications of AI, the learning computation has the ability of generate new instances for the training set. When so, the calculation described in this section can be carried out.

With a dynamic training set, it is possible to take advantage of the points of low entropy in the interpolation scheme: the central idea here is that, given those points, all that needs to be defined for F̅₂ is the value of F₂ at those anchor points. Those points of low entropy are defined by the anchor points in the space of the a parameters. As a result, if those points of low entropy in the a space are translated to points or regions in the input space (x), it is possible to concentrate the instances of the training set at those points or areas of the input space that correspond to points of low entropy in the variable “a”, and minimise the number of instances in the training set.

Also, another central idea to exploit is that, for \hat{F}₂ to be well defined, those regions of the input space that correspond to a unique value of “a”, must have the same value of F(\vec{x}). Those regions are “isovalue hypersurfaces” in the space defined by the input training set. For example, in the case of the example used before, those “isovalue hypersurfaces” are circles centred in the origin of coordinates: given a circle, any point in it has the same value for F(\vec{x}). Hence, if the instances of the training set are concentrated in the isovalue hypersurfaces that correspond to the points of low entropy for the variable a, then it is possible to define F̅₂ with a great deal of precision from very few instances in the training set.

It must be noted that, when the parametrisation in \hat{F}₁ is determined, what is actually being done is determining precisely these “isovalue hypersurfaces”. If, for example, \hat{F}1 goes from a space of, say, 1,000 variables (i.e. n=1000), and the parametrisation has 5 variables (i.e. n_{R}=5), then the “isovalue hypersurfaces” for the function F are five-dimensional hypersurfaces.

When a static training set is used, lots of “isovalue hypersurfaces” are found, with no attention to which corresponds to the anchor points. Now, the calculation is to be optimised further by concentrating the valuation of the function F on those isovalue hypersurfaces that correspond to points of low entropy in the variable a. Hence, not only the parameters of \hat{F}₁ are optimised, but also the instances of the training set.

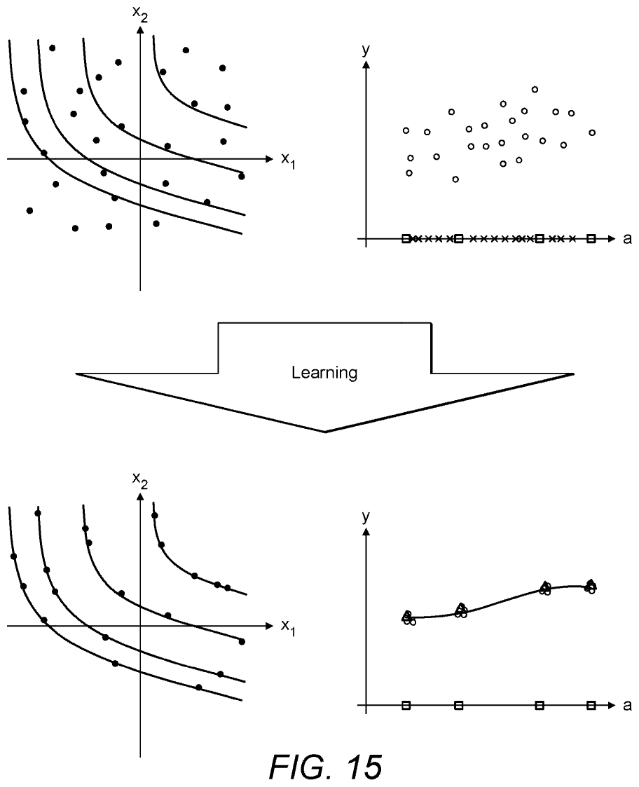

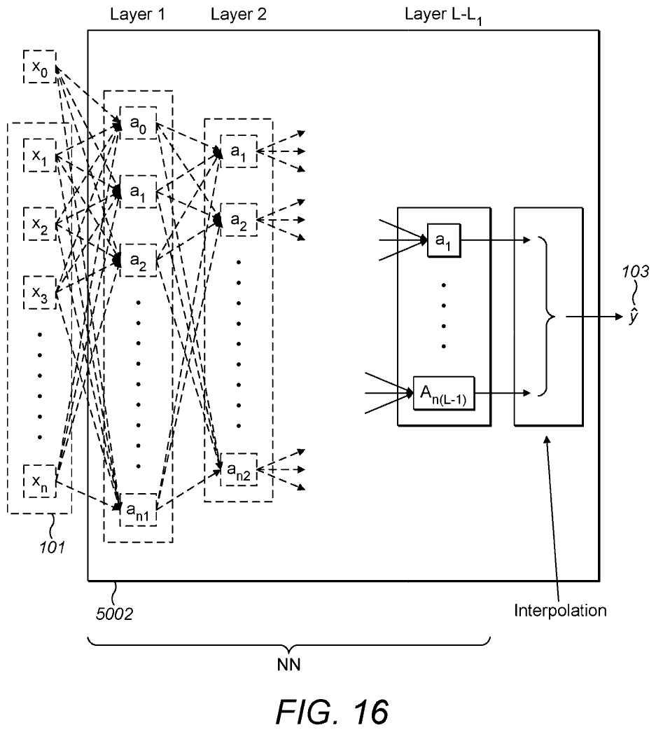

This is illustrated in FIG. 15.

It must be noted that a single variable a is referred to for simplification of speech, and because the illustrative example has only one dimension in the variable a. However, a could be a high-dimensional space, with no loss of generality.

So, the procedure is as follows. Given an interpolation scheme used to define F̅₂ and set in the hyper parameters of the hNN, then a number of instances for the training set are defined randomly; generally, a small number is all that is be needed for this dynamic training embodiment of the invention, because they are going to be optimised. For example, if five per anchor points are selected in the interpolation scheme. Those instances are illustrated with dots in FIG. 15, top left pane. The top right pane illustrates the value of F in those points with circles, and the anchor points of the interpolation scheme with squares. In the top left pane, the curved lines illustrate the isovalue hypersurfaces that correspond to each of the anchor points.

As has been shown in the previous section with reference to FIG. 13, the hNN is considered to have found the parametrisation when the vertical width of the cloud of circles in the top right pane of FIG. 15 becomes very narrow (though iterations). Similarly, the instances of the training set will be optimised when those points concentrate (converge or coalesce) to the isovalue hypersurfaces that correspond to the anchor points. Additionally, if the interpolation scheme is so that the anchor points are points of low entropy, then the instances of the training set will concentrate in points of low entropy when they concentrate to the isovalue hypersurfaces that correspond to the anchor points.

Graphically explained, following FIG. 15, the hNN will be optimised when the “x” in the top right pane are concentrated around the squares (i.e. when the projection of the instances of the input training set under \hat{F}₁ are the anchor points), and when the vertical width of the cloud of circles in the top right pane concentrate around one single value (i.e. the triangles in the bottom right pane), namely converge to a single line as shown in the lower right pane of FIG. 15.

The Computational Procedure for Dynamic Training Sets

The fundamental idea is similar than in the case of static training set: the difference is that the instances of the training set change in each iteration of the training loop (i.e. the dots in FIG. 13, left pane, change in each iteration of the training loop.

To be noted, this can be carried out by adding new instances to the training set, or changing them completely after each iteration. The present embodiment is going to focus in the latter option, but the former option could also apply with no loss of generality.

Under the dynamic training set calculation, in each iteration of the learning loop, the instances of the training set are updated as:

xᵢ^{(j)}:=xᵢ^{(j)}−βdxᵢ^{(j)}

Where β is the learning rate, and dxᵢ^{(j)} is the change to be applied (to be noted, this update is done in parallel to the updates of the w parameters, described in the previous section).

An “input space Distant function”, D, that is a function that is minimised when the instances of training set fall in the isovalue hypersurfaces that correspond to the anchor points of the interpolation (i.e. when the “x” in the top right pane, FIG. 15, are concentrated around the squares) is now defined.

There are many ways a function like that can be defined. For example, each instance can be linked to an anchor point. Then, it can be said that the instance \vec{x}(j), that \hat{F}₁ transforms to a^{(j)}, is linked to the anchor point a*ₖ. Following this the input space Distant function D can be defined as:

D=D(\vec{x})=(a−a*ₖ)²=(\vec{F}₁(\vec{x})−a*ₖ)²

And then,

$${dx}_{i}^{( j )} = \frac{\partial D}{\partial {x}_{i}} evaluated at {{x}^{->}}^{( j )}$$

That link can be done in many ways. For example, it is possible to start numbering the instances in the a axis from the left, and link the first five instances to the first anchor points, the subsequent five instances to the second anchor point, etc. (assuming there are five instances per anchor point). Once that link is stablished, it is possible to let it be fixed throughout the learning loop.

In this way, by applying this update xᵢ^{(j)}:=xᵢ^{(j)}−βdxᵢ^{(j)} to the instances, they are moved towards the isovalue hypersurfaces that correspond to the anchor points of the interpolation scheme, and hence zones of low entropy when the interpolation scheme has points of low entropy as anchor points (as shown in FIG. 15).

Forward and Backward Propagation

Under the embodiments of the present invention, the forward propagation is modified, as it must contain now the interpolation framework. In accordance with the embodiment of the present invention, module 102b (FIG. 6) becomes module 5002, shown in FIG. 16. From the original L layers, the last Lₗ are substituted by an interpolation layer (or a plurality of them, this will be explained later). Hence, the old NN with L layers now becomes a typical prior art NN with (L−Lₗ) layers, plus an extra interpolation layer in accordance with the embodiment of the present invention.

Consequently, the forward propagation now depends on the parameters of typical prior art NN F₁, generically referred to as the w parameters, and the parameters of the interpolation framework, generically referred to as the c parameters.

Then, the backward calculation is modified accordingly. When the computation of the changes in parameters d\vec{w} need to computed, when applying the change rule, the derivatives of the interpolation layers need to be considered. If ŷ is the output of the interpolation layer, and \vec{a}^{[L-L}^{ₗ}^{]} refers to the inputs of the interpolating layer,

$$\frac{\partial {ℒ}^{( j )}}{\partial {w}_{i}} = \frac{\partial {ℒ}^{( j )}}{\partial \hat{y}} \frac{\partial \hat{y}}{\partial {{a}^{->}}^{[ L - {L}_{i} ] ( j )}} \frac{\partial {{a}^{->}}^{[ L - {L}_{i} ] ( j )}}{\partial {w}_{i}}$$

where the term in the middle is given by the interpolation scheme; that is,

$$\frac{\partial \hat{y}}{\partial {{a}^{->}}^{[ L - {L}_{i} ] ( j )}} = \frac{\partial {\overline{\overline{F}}}_{2}}{\partial {{a}^{->}}^{[ L - {L}_{i} ] ( j )}}$$

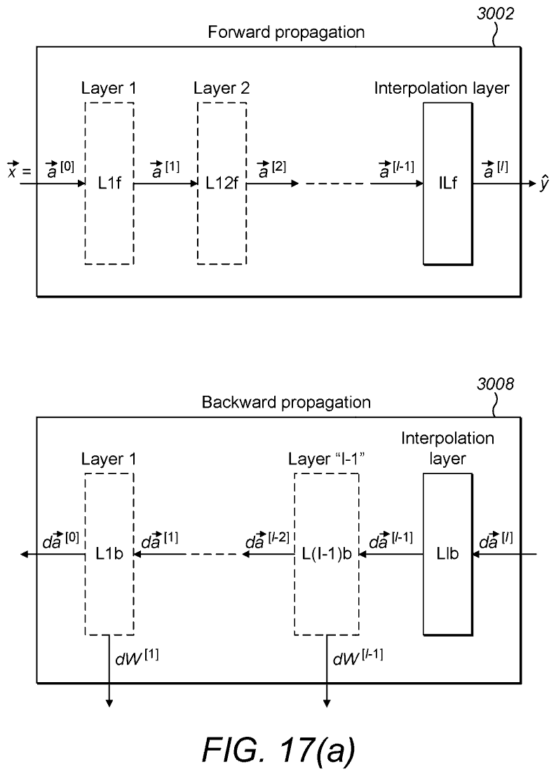

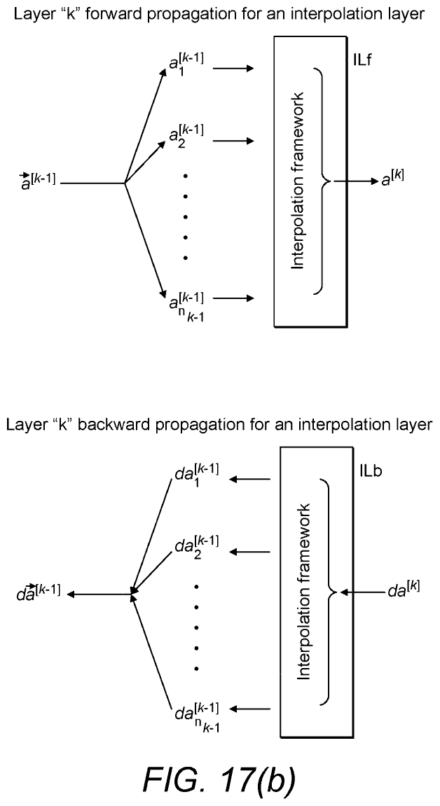

This can be depicted in FIG. 17. Module 302 in prior art (FIG. 9b) becomes in the present embodiment Module 3002 (shown in FIG. 17). In this figure, the last layer is module ILf, which takes the interpolation parameters from database 312 and \vec{a}^{[L-L}^{ₗ}^{]} to compute its output, a^{[L-L}^{ₗ}^{+1]}, which is stored in database 304, and is also ŷ.

The backward propagation module 308 in prior art (FIG. 9b) is also modified in the present embodiment to module 3008 (also shown in FIG. 17). The first module in the computation (that corresponds to the last one in the forward propagation), is now module ILb. It takes as input dŷ, as well as taking the needed information from database 304 and 301, to compute the d\vec{a} for the next layer.

Training Set Update

In the case of dynamic training set of another embodiment of the present invention, module 3000 (of FIG. 9) needs to do the computation explained above, in which each instance j is updated to \vec{x}^{(j)}:=\vec{x}^{(j)}−βd\vec{x}^{(j)} in each iteration of the learning loop. Otherwise the structure of the embodiment is the same as that shown in FIGS. 16 and 17.

Interpolation modules

FIG. 17b shows in more detail the calculations performed by a “k-th” interpolation layer in the forward and backward propagation.

In the forward propagation (module ILf), that takes nₖ₋₁ dimensions, the inputs to the module are the nₖ₋₁ values of the a parameter from the previous “(k−1)-th” layer,

$${{a}^{->}}^{[ k - 1 ]} = [ \begin{matrix}{a}_{1}^{[ k - 1 ]} \\ ⋮ \\ {a}_{{n}_{k - 1}}^{[ k - 1 ]}\end{matrix} ]$$

And the output is the evaluation of the interpolation function for the values of the inputted \vec{a}^{[k-1]}, that gives the value of the a parameter that correspond to this “k-th” layer,

a^{[k]=F̅}₂(\vec{a}^{[k-1]})

a^{[k]} is then stored.

The module can create multidimensional outputs by having an interpolating function for each of the outputs. Here we continue discussing the case of one single output for ease of illustration, without any loss of generality.

As an illustrative example, if the interpolation framework F̅₂ is linear interpolation, the interpolation function provides the value given by a straight line that connects each consecutive par of anchor points. If the interpolation framework is based on Chebyshev polynomials (in its multidimensional version if nₖ₋₁ is greater than one), the output is the value of the sum of the Chebyshev expansion for the given input (\vec{a}^{[k-1]}).

For backward propagation (module ILb), the input to the module is the change of the “k-th” a parameter, da^{[k]}. If the interpolation layer is the last layer in the hNN, then this change is dŷ. The module then uses the derivative of the interpolation function to compute how da^{[k]} translates in the change of \vec{a}^{[k-1]},

$${da}_{i}^{[ k - 1 ]} = \frac{\partial {\overline{\overline{F}}}_{2}}{\partial {a}_{i}^{[ k - 1 ]}} {da}^{[ k ]}$$

As an illustrative example, if the interpolation framework is linear interpolation, the derivative is the slope of the interpolating straight line between consecutive anchor points for the given value of \vec{a}^{[k-1]}. If the interpolation framework is based on Chebyshev polynomials, the derivative is given by the slope of the Chebyshev expansion (in its multidimensional version if nₖ₋₁ is greater than one), for the given value of \vec{a}^{[k-1]}. Note that the values of \vec{a}^{[k-1]} were computed and stored in the forward propagation module 3002. The changes d\vec{a}^{[k-1]} are then stored.

Numerical Tests

The present embodiments have been performance tested again the prior art architectures and the results are set out below. As it is common in the art of AI and NNs, the calculation results are tested using two different sets of data, a training set and a testing set.

The training set is the one used for the calibration of the forward propagation. The testing set is also a set of mₜ instances {\vec{x}^{(k)}, y^{(k)}}ₖ₌₁^{m}^{ₜ} that are independent from the training set, and that are used to k=1 assess the performance of the NN with instances that have not been used to train it.

Calibration of NNs is more of an art than a science, as it is a highly empirical process (i.e. manual calibration of hyper parameters by the researcher) that relies heavily in the know-how and experience of the skilled individual. As a result, it is difficult to perform like-for-like sets of tests. Having said that, when a new problem of NN is presented in front of a skilled professional, the standard way in the art to proceed is to start with a very shallow NN, and start increasing its complexity until positive results are achieved.

Because of this, in this testing the results of a prior-art NN in its simplest form (one neuron, one layer), has been compared with the simplest form of a hNN (one neuron in one layers, and one single interpolation layer). This form of structure makes the results comparable.

In order to illustrate the benefit of the embodiments of the present invention over the prior art, two tests are shown, each for a different function F. For ease of illustration and computation, each test is based on a function of two dimensions in the input space. The NN for each of them is calibrated, as well as the hNN in two modes (static and dynamic training sets). The quality of the results of the NN vs. the hNN is compared.

It must be noted that the function used in each test is declared for illustrative purposes of this document, but the NN or hNN does not know what function it is, it only receives as inputs the training set of instances {\vec{x}^{(k)}, y^{(k)}}.

Performance Tests

Two tests are shown, for two different functions

F(x₁,x₂)=(x₁+x₂)² Test 1

F(x₁,x₂)=(cos(x₁+x₂))³ Test 2

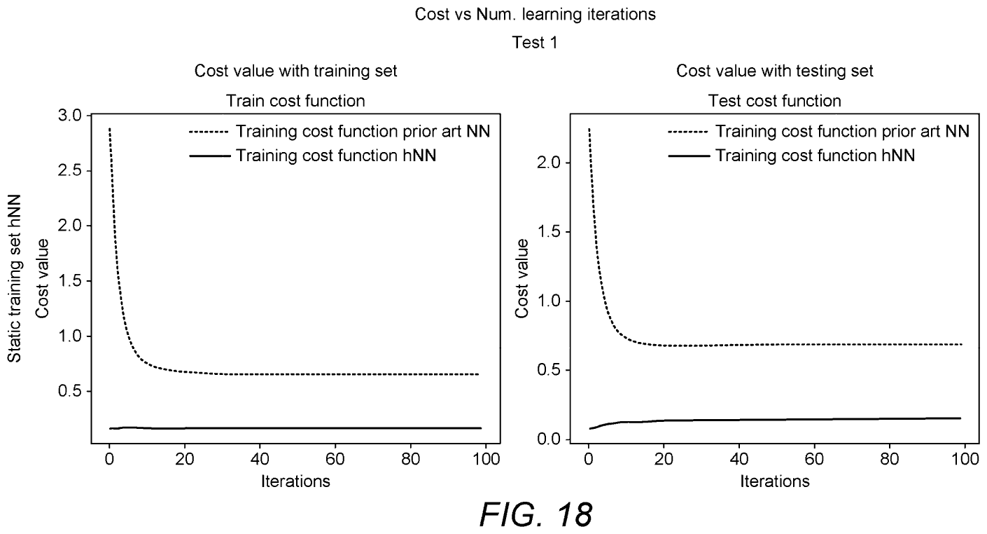

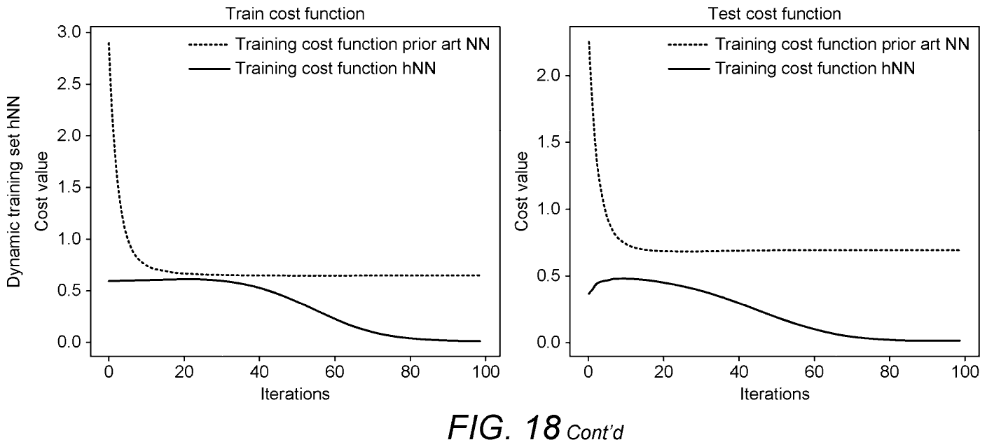

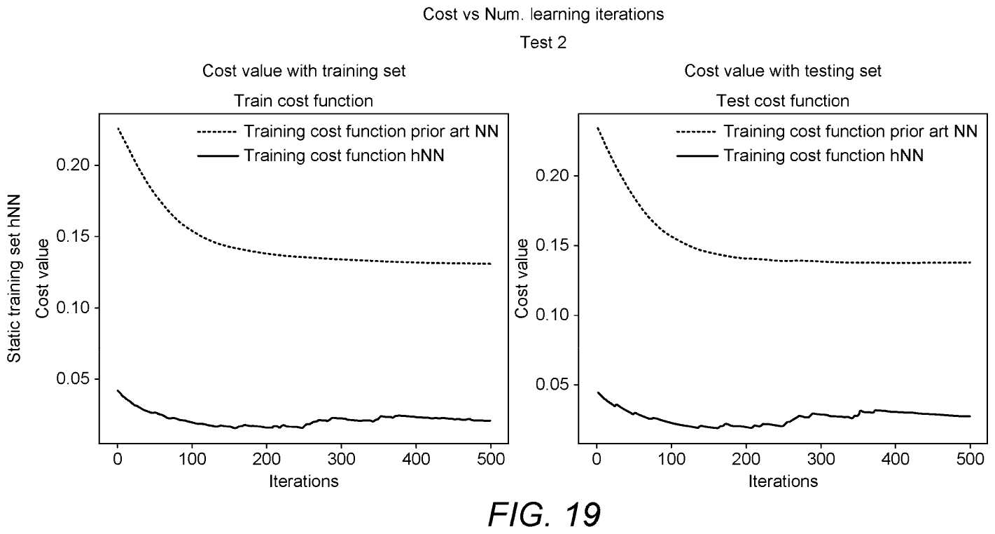

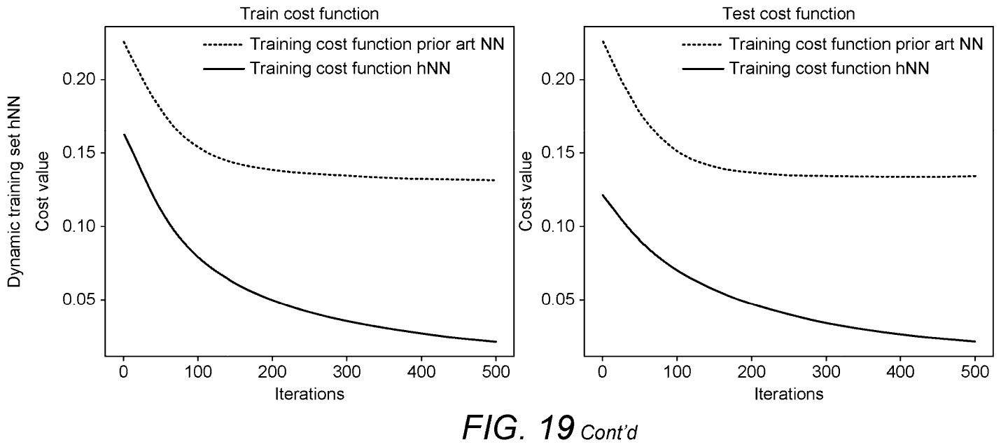

The plots in FIGS. 18 and 19 show the Cost function (vertical axis) as the number of iterations in the learning loop increases (horizontal axis). Each plot shows the results of the prior art NN (dotted line) and the hNN (solid line). The top panes are for a Static training set, the bottom panes for a Dynamic training set for the hNN. The left panes show the results on the Training set, the right pane on the Testing set.

It can be seen in these figures that cost value of the hNN is consistently better (lower) than that of the prior art NN. This means that, for the same number of iterations in the training loop, the hNN always performs better than the prior art NN.

Also, the following table shows the maximum error that the function learnt by the NN, \hat{F}, has, compared to the original function F. This was computed by building a very fine grid of points (\vec{x}), 10,000 points, computing the value of F in those points as well as the value of the function learnt by each of the NNs, \hat{F}, computing the difference between those two values, and taking the maximum (in absolute value) of those numbers as the maximum error. The function \hat{F} was taken when the learning process had finished (i.e. when the Cost function in the training set was stable). This test is important when assessing the quality of a NN because a the Cost function measures a somewhat average of the errors, but it does not say much about outliers; however, this “maximum error” test provides a bound for the error of \hat{F}.

The results are shown in the following table:

| | | hNN | hNN |
|---|---|---|---|
| | Prior art NN | static training set | dynamic training set |
| Test 1 | 3.47 | 0.49 | 0.00000014 |
| Test 2 | 0.59 | 0.18 | 0.16 |

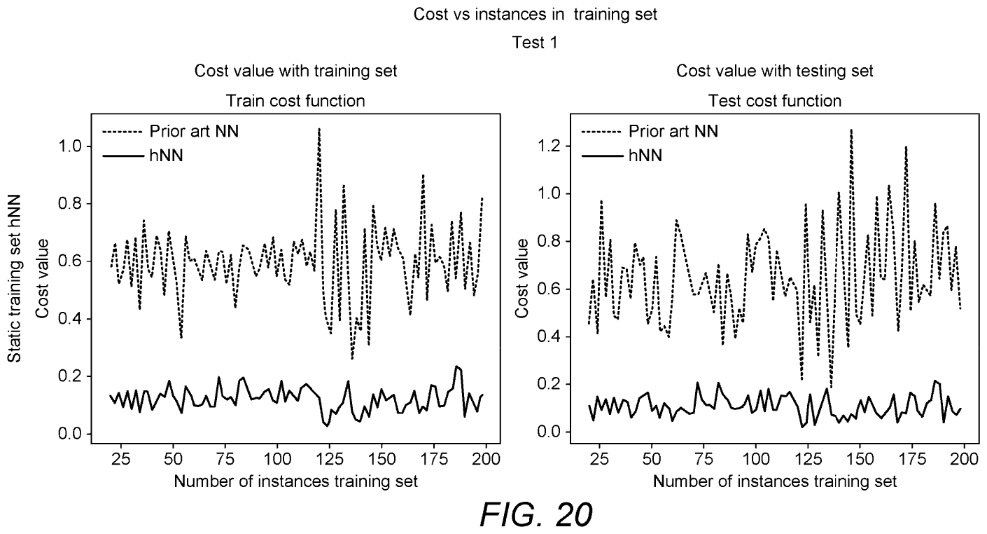

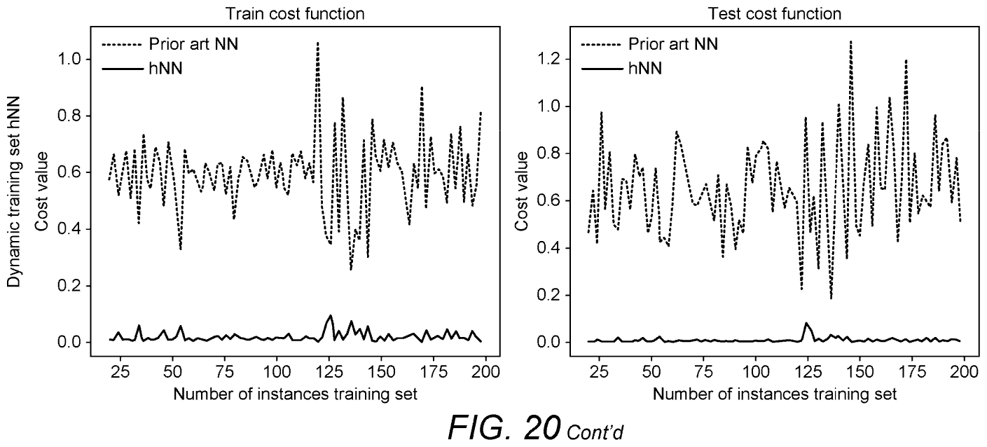

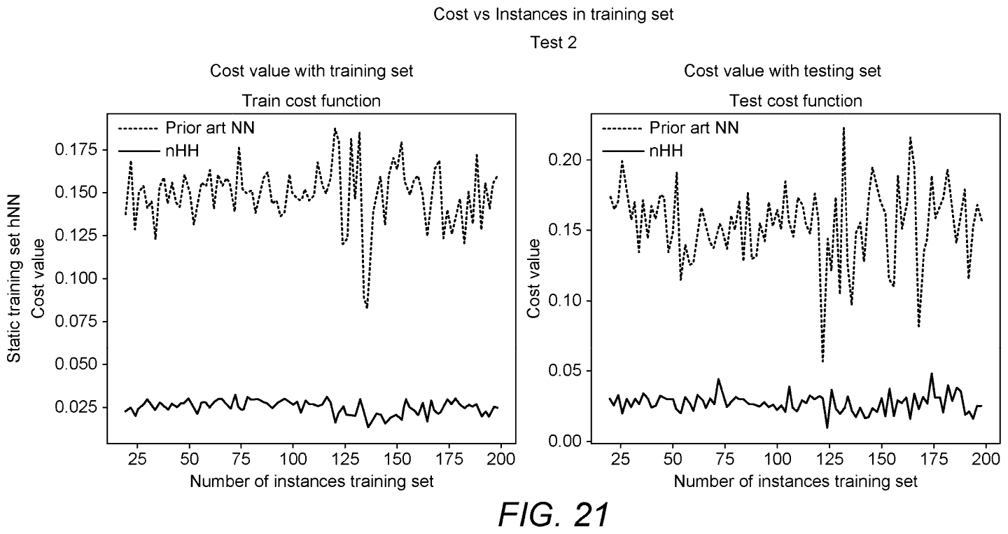

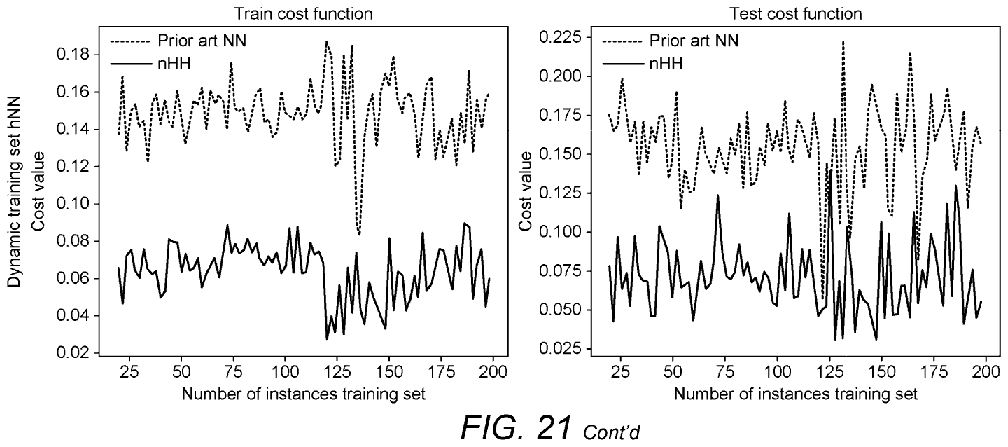

Finally, FIGS. 20 and 21 show the Cost function when the NN has reached its stable state in the learning loop (vertical axis) as the size of the training set increases (horizontal axis). Each plot shows the results of the prior art NN (dotted line) and the hNN (solid line). The top panes are for a Static training set, the bottom panes for a Dynamic training set for the hNN. The left panes show the results on the Training set, the right pane on the Testing set.

It can be seen how, for a given number of instances of the training set, the Cost function is consistently better for the hNN compared to the prior art NN. This shows how the hNN needs less instances in the training set to produce the same or better results. Indeed, in these tests, the hNN is so much better than the prior art NN, that the hNN with very few instances delivers better results than the prior art NN with many instances.

Results

The following can be observed in all tests:
1. Precision—In all cases, the measurement of precision of the prior art NN (dotted lines in FIGS. 18 and 19, first column in table above) compared to hNN shows that the hNN is notably more accurate in the final result than the prior art NN.
For example, looking at FIG. 18, Dynamic training set (bottom panels), for a given number of iterations (e.g. 80), the Cost function of the prior art NN is notably higher than of the hNN (0.7 vs 0.05), indeed around 14 times higher.
Looking at the table above, Test 1, the maximum error or prior art NN is 3.47, while those errors are 0.49 and a staggering 0.0000001 for the hNN, 7 and 10,000,000 times better.
This shows how hNN can be notably better than prior art NN at learning functions.
2. Number of learning iterations—Observing FIGS. 18 and 19 shows clearly how a hNN can be more efficient at learning functions than prior art NNs: a given value of the Cost function can always be achieved with less iterations when using the hNN compared to the prior art NN.
For example, FIG. 19, bottom left pane. Assuming that the value of the acceptable Cost function is set to 0,15. The learning process will achieve that value after around 15 iterations of the learning loop when using the hNN, but it needs 100 iterations when using the prior art NN.
Indeed, this effect is so strong in all other tests performed that the hNN could achieve a better value of the Cost function for any number of iterations of the learning loop; that is, the worst value of the Cost function for the hNN, for any number of iterations, is better than the best value of the Cost function for the prior art NN.
3. Total number of instances in the training set FIGS. 20 and 21 show that the hNN needs a lower number of instances in the training than the prior art NN, as the results with the hNN are better than with the NN for practically any number of instances in the training set.

To be noted, an added benefit that the hNN shows to have compared to the prior art NN is its stability. FIGS. 20 and 21 show more stable results for the hNN.

Also, it must be noted that these examples show a relatively low number of iterations compared to the many thousand (or more) that are sometimes used in the NNs of the prior art. The reason is that the dimensionality of the input space is low, only 2. As that dimensionality grows, the number of iterations increases, but the relative benefit of hNN vs prior art NNs prevails in general.

### CONCLUSIONS

It has been shown with two tests how, for functions that are parametrizable, using an embodiment with an interpolation layer in combination with prior art layers of NN, can increase the efficiency of the learning step.

As discussed above, this provides a benefit at two levels. Firstly, hNN can be more efficient at the learning step than prior art NNs, which means it can be executed faster and with lower computational cost. Secondly, given that the learning step is typically performed within an empirical process of finding the right hyper parameters for the NN (i.e. its architecture), having a more efficient NN means that this overall process will be also more efficient, allowing for more trial-and-error learning calculations with the hNN, because it can be done either faster or more economically, or both.

hNN Vs Prior Art NN

It must be noted that, when F=F₂·F₁, its prior art NN version will be \hat{F}_{NN}=\hat{F}₂·\hat{F}₁, because of the intrinsic properties of the forward propagation. In its hNN version, \hat{F}_{hNN}=F̅₂·F₁, so as long as F̅2 is more efficient than \hat{F}₂, F_{hNN} will be more efficient than \hat{F}_{NN}.

The intrinsic limitation of F̅₂ is the dimensionality of its input space.

So, if an \hat{F}₁ is found that is good at reducing the dimensionality enough for the interpolation of F̅₂ to work well, then \hat{F}_{hNN} will be more efficient than \hat{F}_{NN}.

And a central point is that, in standard prior art NN, many times F₁ is set to reduce the dimensionality, so replacing \hat{F}₂ by its interpolation equivalent, F̅2, makes sense and should improve overall performance.

Slides of Interpolations in hNN

Whilst specific ways in which the combination of interpolation techniques can be applied to standard NNs has been described in the embodiments set out above, it is to be appreciated that different types of combinations of interpolation techniques and standard NNs can be applied to also realise benefits and accordingly the invention is not so limited to the specific ways described herein. For example the present invention can be applied using interpolation techniques via Slides.

As has been explained above prior art interpolation technique via Slides exist. It must be noted that such an interpolation framework is no more than a linear combination of interpolation frameworks, hence when seeing those frameworks with a NN mindset, it is possible to see them as layers of interpolations combined in a network-like fashion. It must be understood, hence, that the present invention can be naturally extended to staging together a plurality of interpolating layers in a network-like fashion, with no loss of generality of the results shown.

Also, in this document an hNN has been described as a NN with a (or a number of) interpolation layer(s) at the end. The design and testing of a NN is a highly empirical process, in which the skilled individual tries several configurations of hyper parameters until a satisfactory combination is found. As a result, the principle explained in this document could be easily and naturally extended to architectures that have interpolation layers in-between layers of neurons, or in between neurons.

The present embodiment can be considered to be a NN that combines groups of neurons with groups of interpolation schemes. Preferably the interpolation schemes are set in the last few layers of the NN. In one embodiment, the interpolation scheme uses one layer, in the last layer of the NN.

The interpolation scheme(s) used is preferably one based on orthogonal functions (spectral decomposition). In some embodiments, preferably the interpolation scheme(s) is one based on Chebyshev polynomials, or Legendre polynomials or Jacobi polynomials. Also, preferably the function being approximated in the NN is parametrizable or partially parametrizable.

1. A non-homogeneous machine learning architecture for approximating an overall function as a composition of at least a first approximation function and a second approximation function, the non-homogeneous machine learning architecture comprising:
a neural network architecture for providing the first approximation function, the neural network architecture being configured to receive a plurality of input values for the overall function as an input to the first approximation function, and to apply the first approximation function to the received input values to generate a plurality of neural network output values; and,
an interpolation architecture for providing the second approximation function, the interpolation architecture being configured to receive the plurality of neural network output values as an input to the second approximation function, and to apply the second approximation function to generate one or more interpolation output values to be used in approximating at least one output value of the overall function.

2. A non-homogeneous machine learning architecture according to claim 1,
wherein the number of the one or more interpolation output values is less than the number of the plurality of neural network output values.

3. A non-homogeneous machine learning architecture according to claim 1, wherein the number of the plurality of neural network output values is less than the number of the plurality of input values.

4. A non-homogeneous machine learning architecture according to any previous claim, wherein the neural network architecture comprises a plurality of concatenated layers, each layer having a dimension defined by a number of processing nodes within the respective layer, wherein the dimension of an initial layer of the plurality of concatenated layers is greater than or equal to the plurality of input values for the overall function, and wherein the dimension of a final layer of the plurality of concatenated layers is both equal to the plurality of neural network output values and less than the dimension of the initial layer.

5. A non-homogeneous machine learning architecture according to claim 4, wherein the neural network architecture comprises a plurality of trained neural network parameters including a trained weight associated with each of the respective processing nodes, wherein the interpolation architecture comprises a plurality of trained interpolation parameters including a plurality of trained coefficients of the second approximation function, and wherein the trained neural network parameters and the trained interpolation parameters were previously determined as part of a training phase utilising forward and backward propagation through the non-homogeneous machine learning architecture.

6. A non-homogeneous machine learning architecture according to claim 1, wherein the interpolation architecture is configured to reduce the plurality of neural network output values to obtain a plurality of interpolation input values as the input to the second approximation function.

7. A non-homogeneous machine learning architecture according to claim 6, wherein the interpolation architecture is configured to perform a principal component analysis to reduce the plurality of neural network output values, the principal component analysis comprising: selecting a subset of eigenvalues of a correlation matrix of the plurality of neural network output values; and, using eigenvectors corresponding to the subset of eigenvalues to obtain the plurality of interpolation input values;
optionally wherein the interpolation architecture is configured to perform the principal component analysis when the number of the plurality of neural network output values has an order of magnitude of 10² or greater.

8. (canceled)

9. A non-homogeneous machine learning architecture according to any previous claim, wherein the second approximation function comprises a function expansion on a functional base formed by a series of orthogonal functions or an approximation to a function expansion on a functional base formed by a series of orthogonal functions, or combinations of those expansions or of their approximations;
optionally wherein the series of orthogonal functions is one of the group comprising:
sines, cosines, sines and cosines, Bessel functions, Gegenbauer polynomials, Hermite polynomials, Laguerre polynomials, Chebyshev polynomials, Jacobi polynomials, Spherical harmonics, Walsh functions, Legendre polynomials, Zernike polynomials, Wilson polynomials, Meixner-Pollaczek polynomials, continuous Hahn polynomials, continuous dual Hahn polynomials, a classical polynomials described by the Askey scheme, Askey-Wilson polynomials, Racah polynomials, dual Hahn polynomials, Meixner polynomials, piecewise constant interpolants, linear interpolants, polynomial interpolants, gaussian process based interpolants, spline interpolants, barycentric interpolants, Krawtchouk polynomials, Charlier polynomials, sieved ultraspherical polynomials, sieved Jacobi polynomials, sieved Pollaczek polynomials, Rational interpolants, Trigonometric interpolants, Hermite interpolants, Cubic interpolants, and Rogers-Szegö polynomials.

10. (canceled)

11. A non-homogeneous machine learning architecture according to claim 1, wherein the overall function is approximated as a composition of the first approximation function and the second approximation function, and wherein the generated at least one interpolation output value is the approximation of the at least one output value of the overall function.

12. A non-homogeneous machine learning architecture according to claim 1, wherein the overall function is approximated as a composition of the first approximation function, the second approximation function, and a third approximation function, and the non-homogeneous machine learning architecture comprising:
a neural network or an additional homogeneous or non-homogeneous machine learning architecture for providing the third approximation function, the neural network or additional homogeneous or non-homogeneous machine learning architecture being configured to receive the generated at least one interpolation output value as an input to the third approximation function, and to apply the third approximation function to the received at least one interpolation output value to generate one or more of the neural network or additional homogeneous or non-homogeneous machine learning output values as the approximation of the at least one output value of the overall function.

13. A training phase method for training a non-homogeneous machine learning architecture according to any previous claim, the neural network architecture comprising a plurality of training neural network parameters to be tuned during the training phase, and the interpolation architecture comprising a plurality of training interpolation parameters to be tuned during the training phase, the method comprising providing a plurality of training samples, each sample including a plurality of input training values, and one or more corresponding output training values, for the overall function, and the method comprising repeating the steps of:
performing a forward propagation step in which each of the plurality of training samples are executed by successively applying the first and second approximation functions to obtain an approximated value of each of the one or more outputs of the overall function;
applying a cost function based on a difference between the approximated values and the respective training values of the one or more outputs of the overall function to determine a distance metric value; and,
performing a backward propagation step in which the training neural network parameters are updated in dependence on the determined distance metric value, until the determined distance metric value satisfies a predetermined condition or until the steps of forward propagation, applying a cost function and backward propagation have been performed a predefined number of times.

14. A method according to claim 13, further comprising: setting a plurality of anchor points in the input space of the second approximation function prior to performing the repeated steps of forward propagation, applying a cost function, and backward propagation, and wherein the forward propagation step further comprises:
approximating a value of the one or more outputs of the overall function at each of the plurality of anchor points using the plurality of neural network outputs received from the neural network architecture; and
determining updated values of the training interpolation parameters based on the approximated values of the one or more outputs of the overall function at each of the plurality of anchor points, wherein the one or more outputs of the overall function for each of the training samples in the forward propagation step is determined using the updated values of the training interpolation parameters, optionally further comprising using a completion technique to reduce the plurality of training samples used in the training phase.

15. A method according to claim 14, wherein approximating the value of the one or more outputs of the overall function at each of the plurality of anchor points comprises: for each anchor point, approximating the value of the one or more outputs of the overall function using the training value for the one or more outputs of the overall function corresponding to the plurality of neural network outputs for at least one of the training samples.

16. A method according to claim 15, wherein, for each anchor point,
approximating the value of the one or more outputs of the overall function comprises:
selecting one or more of the training samples based on a proximity of the plurality of neural network outputs corresponding to each training sample relative to the anchor point, and
using the training value for the one or more outputs of the selected training samples to approximate the value of the one or more outputs of the overall function.

17. A method according to claim 15, further comprising, for each anchor point, selecting those training samples in which the value of the corresponding plurality of neural network outputs is within a predefined anchor point distance of the value of the anchor point for use in approximating the value of the one or more outputs of the overall function for the anchor point.

18. (canceled)

19. A method according to claim 14, wherein the backward propagation step comprises: updating the plurality of training samples, wherein for a given one of the training samples the training values are updated in dependence on a training sample distance between the plurality of neural network output values generated by the first approximation function using the input training values and a given one of the anchor points in order to reduce the training sample distance.

20. A method according to claim 14, wherein the second approximation function comprises a function expansion on a functional base formed by a series of orthogonal functions or an approximation to a function expansion on a functional base formed by a series of orthogonal functions, and wherein the anchor points are the zeros or the extrema points of each of orthogonal function, or a subset of the zeros or the extrema points.

21. A method according to claim 14, the method comprising determining at least one sub-function of the second approximation function, the at least one sub-function being a function of a subset of the plurality of neural network outputs, wherein in the forward propagation step the determined at least on sub-function is applied as the second approximation function.

22. A method according to claim 21, wherein the at least one sub-function is determined using a sliding technique.

23. (canceled)

24. (canceled)

25. A computer program product storing instructions thereon that when executed by one or more electronic processors causes the one or more processors to:
perform a forward propagation step in which each of the plurality of training samples are executed by successively applying the first and second approximation functions to obtain an approximated value of each of the one or more outputs of the overall function;
apply a cost function based on a difference between the approximated values and the respective training values of the one or more outputs of the overall function to determine a distance metric value;
perform a backward propagation step in which the training neural network parameters are updated in dependence on the determined distance metric value, until the determined distance metric value satisfies a predetermined condition or until the steps of forward propagation, applying a cost function and backward propagation have been performed a predefined number of times; and
set a plurality of anchor points in the input space of the second approximation function prior to performance of forward propagation, application of a cost function, and backward propagation, wherein the forward propagation further comprises instructions that when executed causes the one or more processors to:
approximate a value of the one or more outputs of the overall function at each of the plurality of anchor points using the plurality of neural network outputs received from the neural network architecture; and
determine updated values of the training interpolation parameters based on the approximated values of the one or more outputs of the overall function at each of the plurality of anchor points, wherein the one or more outputs of the overall function for each of the training samples in the forward propagation is determined by use of the updated values of the training interpolation parameters.

26. (canceled)

27. (canceled)

28. (canceled)
